(19) United States
(12) Patent Application Publication
(10) Pub. No.: US 2023/0180673 A1
(43) Pub. Date: Jun. 15, 2023

(54) CROP CRATE

(71) Applicant: 25:2 SOLUTIONS LLC, Pocatello, ID (US)

(72) Inventors: Eric Jackson, Pocatello, ID (US); Kimberly Jackson, Pocatello, ID (US); Hermilo Hernandez, Pocatello, ID (US); Jose Ortiz, Pocatello, ID (US); Jonathan Powell, Pocatello, ID (US)

(21) Appl. No.: 18/166,380

(22) Filed: Feb. 8, 2023

Related U.S. Application Data
(63) Continuation of application No. PCT/US21/45564, filed on Aug. 11, 2021.
(60) Provisional application No. 62/706,342, filed on Aug. 11, 2020.

(51) Int. Cl. A01G 9/029; A01G 31/06

(52) U.S. Cl. CPC A01G 9/029; A01G 31/06

(57) ABSTRACT

An innovative modular indoor growing system uses a holistic approach that includes an heirloom/ancestral seed collection sourced from global seed banks, an in-home easy-to-use production system, passport-style information for people to explore or experience the global seed diversity of a crop, onboard sensors and cameras for real-time monitoring of the crop, virtual assistance facilitating the selection, development, and creation of new varieties, and a crowd sourced data collection network that relies on artificial intelligence to build a state-of-the-art knowledge base for product optimization and consumer intelligence.

### CROSS REFERENCE TO RELATED APPLICATIONS

This Application is a By-Pass Continuation of PCT/US2021/045564, filed Aug. 11, 2021, which claims priority to provisional patent application U.S. Ser. No. 62/706,342, filed Aug. 11, 2020. The provisional patent application is herein incorporated by reference in its entirety, including without limitation, the specification, claims, and abstract, as well as any figures, tables, appendices, or drawings thereof.

### FIELD OF THE INVENTION

The present invention relates generally to an apparatus, system, and/or corresponding method of use in at least the agricultural, gardening, and emerging indoor farming industries. More particularly, but not exclusively, the present invention relates to an automated, modular apparatus for selecting, growing, monitoring, and breeding crops at nearly all sites, including those indoors.

### BACKGROUND OF THE INVENTION

The background description provided herein gives context for the present disclosure. Work of the presently named inventors, as well as aspects of the description that may not otherwise qualify as prior art at the time of filing, are neither expressly nor impliedly admitted as prior art.

Consumers are looking for new and exciting food offerings focused on health and wellbeing. They are seeking products that are more nutritious, less processed, and developed with greater transparency using sustainable practices. Although fruits and vegetables are perceived to be nutritious and fresh by consumers, every year bacterial contaminations have driven the U.S. Centers for Disease Control and Prevention (CDC) to issue warnings around their safety while the FDA has listed leafy greens (1), tomatoes (8), spouts (9), and berries (10) as four of the top ten foods that can make you ill. Additionally, 60 million tons of produce is wasted every year by retailers and consumers drawing into question sustainability. The emerging indoor farming industry has mitigated the main source of bacterial contamination in field grown vegetables, but many startups are failing due to technology and labor cost. The indoor community has also focused on the physical side of the process while relying on the same varieties or genetics that are used in the field and have done little to combat waste streams.

Thus, there exists a need in the art for an innovative solution that provides exciting food options grown “on location that can simultaneously teach persons consuming these foods how those foods are grown, selected, and bred in an efficient and sustainable manner.

### SUMMARY OF THE INVENTION

The following objects, features, advantages, aspects, and/or embodiments, are not exhaustive and do not limit the overall disclosure. No single embodiment need provide each and every object, feature, or advantage. Any of the objects, features, advantages, aspects, and/or embodiments disclosed herein can be integrated with one another, either in full or in part.

It is a primary object, feature, and/or advantage of the present invention to improve on or overcome the deficiencies in the art.

It is a further object, feature, and/or advantage of the present invention to provide individuals, families, and organizations with clean food, food that is safe to consume, adventure, new experiences, connection, and community.

It is still yet a further object, feature, and/or advantage of the present invention to enhance sustainability.

It is still yet a further object, feature, and/or advantage of the present invention to educate persons regarding real consumer intelligence (CI), variety selection and development, plant breeding, and highly personalized crops. Ideally, the educational process can create an economic windfall as a result of enabling academic organizations and students with a highly sophisticated understanding(s) of mechanical engineering, computer science & artificial intelligence, plant breeding, seed selection, and/or botany.

The modular growing system disclosed herein can be used in a wide variety of applications. For example, the modular growing system can be used to grow an enhanced variety of food options on site, in educational settings, to create suitable environments for growing non-native plants that cannot survive in the natural environment of a particular geographic locations, and for commercial purposes.

It is still yet a further object, feature, and/or advantage of the present invention to lend, distribute, and/or share seed. The use of a seed library instead of a seedbank can avoid the need to store or hold germplasm or seeds against possible destruction. Seed libraries can be more easily disseminate seed to the public. This better preserves the shared plant varieties through propagation and further sharing of seed.

It is still yet a further object, feature, and/or advantage of the present invention to provide universal solutions to problems that are complaint with all regulatory authorities around the globe. For example, the modular growing system provided herein aims to be compliant with all U.S. Drug and Food Administration regulations, the U.S. Clean Water Act, analogous organizations in foreign countries, and the like.

It is still yet a further object, feature, and/or advantage of the present invention to facilitate the growth of dwarf plants, shorten plant life cycles, and/or use a wide variety of hormones, including auxins, gibberellins (GA), abscisic acid (ABA), cytokinins (CK), salicylic acid (SA), ethylene (ET), jasmonates (JA), brassinosteroids (BR), and peptides, to decipher a greater amount of genetic information and botanical data from said plants in a shorter amount of time. This can rapidly increase the amount of scientific discovery that can be accomplished with regard to the genetic makeup of existing and theoretical plant varieties.

It is still yet a further object, feature, and/or advantage of the present invention to design root chambers that can accommodate hydro, aeroponic, and hybrid growing methods.

It is preferred the modular growing system be safe to use, cost effective, and durable. For example, the modular growing system can be adapted to resist thermal degradation and thermal transfer, especially where the user could be exposed to extreme amounts of heat. The risk of injury from use of electrical components therewithin can also be reduced through the use of proper wiring practices, waterproof housings, grounded connections, and construction materials known not to accumulate static buildup. The structural components of the modular growing system can be selected and/or chosen to mitigate mechanical failure (e.g., cracking, crumbling, shearing, creeping) caused by excessive and/or prolonged exposure to tensile and/or compressive forces acting on same. Care should be taken to ensure electrical components do not come into contact with water within the reservoir during assembly, transport, and/or disassembly of the growing system into/from its modular components.

At least one embodiment disclosed herein comprises a distinct aesthetic appearance. Ornamental aspects can help capture a consumer's attention and/or identify a source of origin of a product being sold. Said ornamental aspects will not impede functionality of the present invention. For example, wooden crates can be designed with a farm-fresh design and function as a fruit and veggie stand. The crate can even be stained to match existing cabinets or color schemes in the home or left unstained giving the customer the ability to customize it downstream.

Methods can be practiced which facilitate use, manufacture, assembly, maintenance, and repair of a modular growing system according to any one or more of the aspects described above. Additionally, aspects of the modular growing system can be separated into subsystems or components that uniquely accomplish one, some, or all of the previously stated objectives.

These and/or other objects, features, advantages, aspects, and/or embodiments will become apparent to those skilled in the art after reviewing the following brief and detailed descriptions of the drawings. Furthermore, the present disclosure encompasses aspects and/or embodiments not expressly disclosed but which can be understood from a reading of the present disclosure, including at least: (a) combinations of disclosed aspects and/or embodiments and/or (b) reasonable modifications not shown or described.

### BRIEF DESCRIPTION OF THE DRAWINGS

Several embodiments in which the present invention can be practiced are illustrated and described in detail, wherein like reference characters represent like components throughout the several views. The drawings are presented for exemplary purposes and may not be to scale unless otherwise indicated.

FIG. 1 renders an isometric view of an exemplary modular system for growing crops indoors.

FIG. 2 renders a top elevation view of the system shown in FIG. 1.

FIG. 3 renders a front elevation view of the system shown in FIG. 1.

FIG. 4 renders a side elevation view of the system shown in FIG. 1.

FIG. 5 renders an exploded view of the system shown in FIG. 1.

FIG. 6 renders a front elevation view of the exploded view shown in FIG. 5.

FIG. 7 renders a side elevation view of the exploded view shown in FIG. 5.

FIG. 8 illustrates a detailed perspective view of the sensor that is implemented within the growth chamber of the system of FIG. 1.

FIG. 9 renders an isometric view of a first embodiment of a potential structural base for supporting plants grown within the system of FIG. 1.

FIG. 10 renders a top elevation view of the base shown in FIG. 9.

FIG. 11 renders a front elevation view of the base shown in FIG. 9.

FIG. 12 renders a side elevation view of the base shown in FIG. 9.

FIG. 13 renders an isometric view of a second embodiment of a potential structural base for supporting plants grown within the system of FIG. 1.

FIG. 14 renders a bottom elevation view of the base shown in FIG. 12.

FIG. 15 renders a front elevation view of the base shown in FIG. 12.

FIG. 16 renders a side elevation view of the base shown in FIG. 12.

FIG. 17 renders an isometric view of a third embodiment of a potential structural base for supporting plants grown within the system of FIG. 1.

FIG. 18 renders a bottom elevation view of the base shown in FIG. 17.

FIG. 19 renders a front elevation view of the base shown in FIG. 17.

FIG. 20 renders a side elevation view of the base shown in FIG. 17.

FIG. 21 renders an isometric view of a fourth embodiment of a potential structural base for supporting plants grown within the system of FIG. 1.

FIG. 22 renders a bottom elevation view of the base shown in FIG. 21.

FIG. 23 renders a front elevation view of the base shown in FIG. 21.

FIG. 24 renders a side elevation view of the base shown in FIG. 21.

FIG. 25 renders an isometric view of a fifth embodiment of a potential structural base for supporting plants grown within the system of FIG. 1.

FIG. 26 renders a bottom elevation view of the base shown in FIG. 25.

FIG. 27 renders a front elevation view of the base shown in FIG. 25.

FIG. 28 renders a side elevation view of the base shown in FIG. 25.

FIG. 29 renders an isometric view of a sixth embodiment of a potential structural base for supporting plants grown within the system of FIG. 1.

FIG. 30 renders a bottom elevation view of the base shown in FIG. 29.

FIG. 31 renders a front elevation view of the base shown in FIG. 29.

FIG. 32 renders a side elevation view of the base shown in FIG. 29.

FIG. 33 renders an isometric view of a seventh embodiment of a potential structural base for supporting plants grown within the system of FIG. 1.

FIG. 34 renders a bottom elevation view of the base shown in FIG. 33.

FIG. 35 renders a front elevation view of the base shown in FIG. 33.

FIG. 36 renders a side elevation view of the base shown in FIG. 33.

FIG. 37 renders an isometric view of an exemplary cap which can be shipped with one or more of the potential structural base(s) shown previously throughout FIGS. 9-36.

FIG. 38 renders a bottom elevation view of the cap shown in FIG. 37.

FIG. 39 renders a front elevation view of the base shown in FIG. 37.

FIG. 40 renders a side elevation view of the base shown in FIG. 37.

FIG. 41 is a photograph capturing a real-life example of the system shown in FIG. 1.

FIG. 42 is a photograph tracking progress of pods grown within the real-life example shown in FIG. 41.

FIG. 43 is a photograph capturing an environmental view of the real-life example shown in FIG. 41.

FIG. 44 is a photograph capturing a detailed view of a water reservoir used in the real-life example shown in FIG. 41.

FIG. 45 is a photograph capturing a detailed view of a control box used in the real-life example shown in FIG. 41.

FIG. 46 shows a schematic view of electrical hardware usable within the control box of FIG. 45.

FIG. 47 shows aspects of an exemplary graphical user interface implementing a virtual assistant customized for use with the modular growing system shown in FIG. 1.

FIG. 48 shows additional aspects of the graphical user interface of FIG. 47.

FIG. 49 shows further aspects of the graphical user interface of FIG. 47.

FIG. 50 shows even more aspects of the graphical user interface of FIG. 47.

FIG. 51 shows yet even more aspects of the graphical user interface of FIG. 47.

An artisan of ordinary skill in the art need not view, within isolated figure(s), the near infinite number of distinct permutations of features described in the following detailed description to facilitate an understanding of the present invention.

### DETAILED DESCRIPTION OF THE INVENTION

The present disclosure is not to be limited to that described herein. Mechanical, electrical, chemical, procedural, and/or other changes can be made without departing from the spirit and scope of the present invention. No features shown or described are essential to permit basic operation of the present invention unless otherwise indicated.

### Design

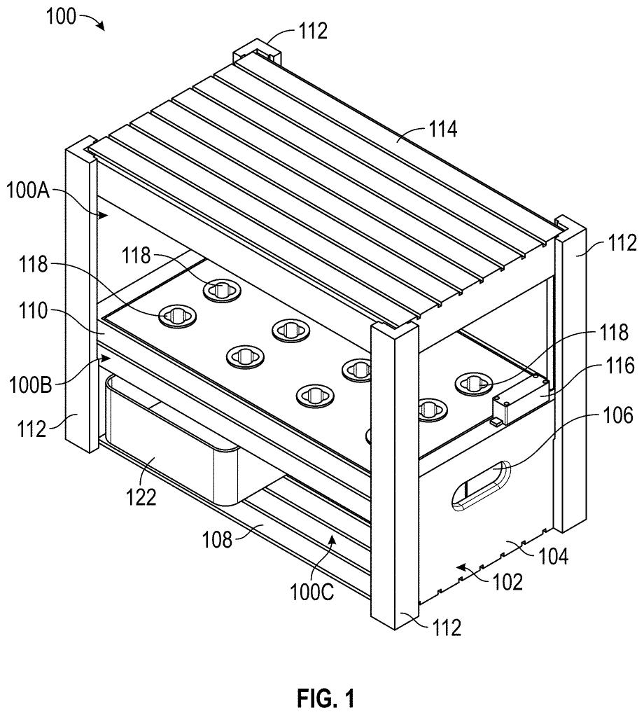

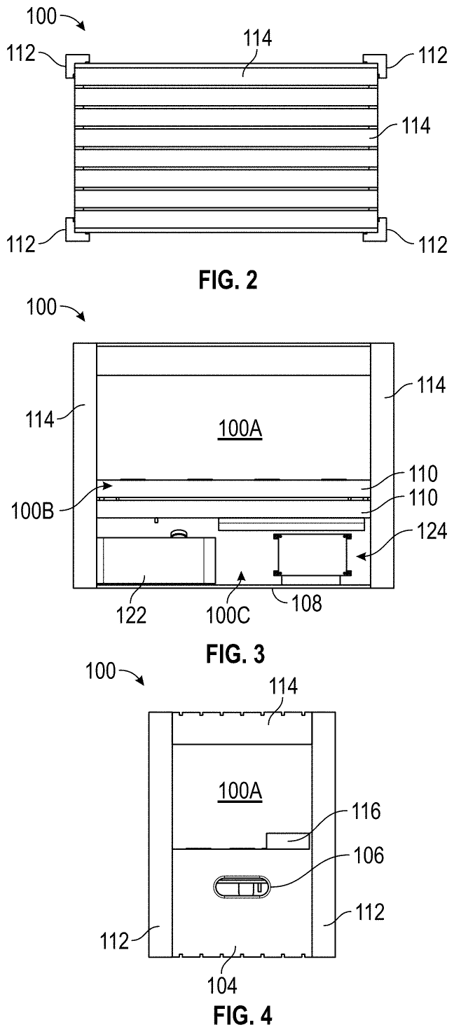

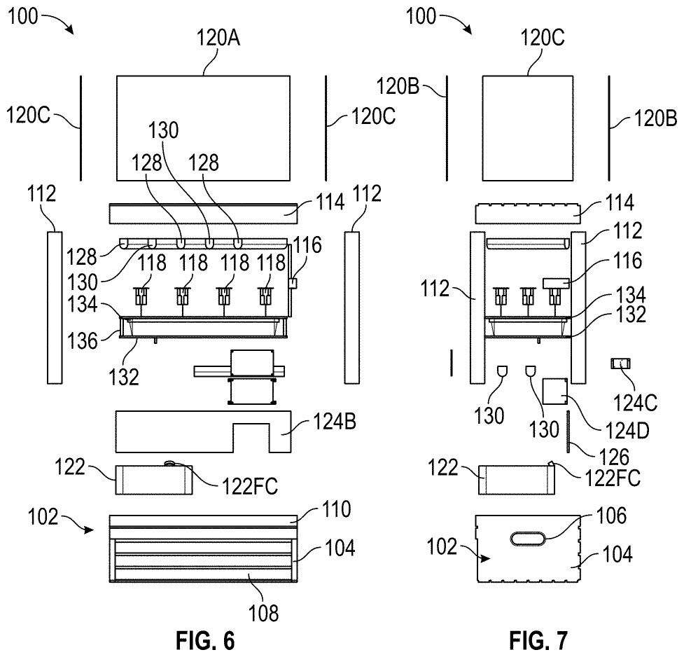

FIGS. 1-8 utilize computer aided design (“CAD”) to emphasize non-limiting aspects of the modular growing system 100. As shown, the modular growing system 100 includes three major zones; in ascending order, the zones are: the germination chamber 100C; the root chamber 100B; and the growth chamber 100A. Though not shown, it is possible to include less or more than major three zones within the modular growing system 100, depending on the particular application for the modular growing system 100.

The germination chamber 100C is where the development of plants from a seed or spore occurs after a period of dormancy. The primary structure of the germination chamber is basket 102. The basket 102 acts a container used to hold or carry things, such as water reservoir 122.

The basket 102 comprises sidewalls 104. The sidewalls 104 include centrally located cut-outs that create handles 106. The handles 106 allow the modular growing system 100 to be more easily picked up, held, transported, and controlled. Germination chamber planks 108 run along the bottom and rear of the basket 102. The germination chamber planks 108 are thin, flat, and elongated members. Laid side by side, the germination chamber planks 108 provide the germination chamber 100C with a floor and, separately, a backwall. Alternatively, a single surface (not shown) can make up the floor and/or backwall in lieu of using the germination chamber planks 108.

The germination chamber 100C is typically open at the front. This allows plants and other objects to be placed into the germination chamber 100C without needless obstruction. That said, a front door or panel can be included where one is preferred for aesthetic purposes or there is a need to quarantine the germination chamber 100C.

In a fully assembled modular growing system 100 (see FIG. 1), the root chamber 100B is placed directly above the germination chamber 100C toward the top of the basket 102. The root chamber 100B is almost completely enclosed by the basket 102 and root chamber planks 110. This allows the root chamber 100B to best contain roots from plants being grown within the growth chamber 100A. The root chamber planks 110 are thin, flat, and elongated members.

The root chamber 100B is designed to hold a plurality of structural bases 118. The structural bases 118 are used to facilitate growth of plants within the growth chamber. A removable lid acts as a ground level surface 134 for a seedling bay of the root chamber 100B. The removable nature of the lid allows for easier cleaning of the system 100. The seedling bay floor 136 acts as a floor for the root chamber 100B and/or a ceiling for the germination chamber 100A.

The root chamber 100B utilizes a water passage designed to minimize the occurrence of leaks, and where leaks are unavoidable, mitigate catastrophes. For example, depending on where the water is coming from, the water passage can route any leaks directly back into the water reservoir 122. This effectively minimizes any catastrophic leaks.

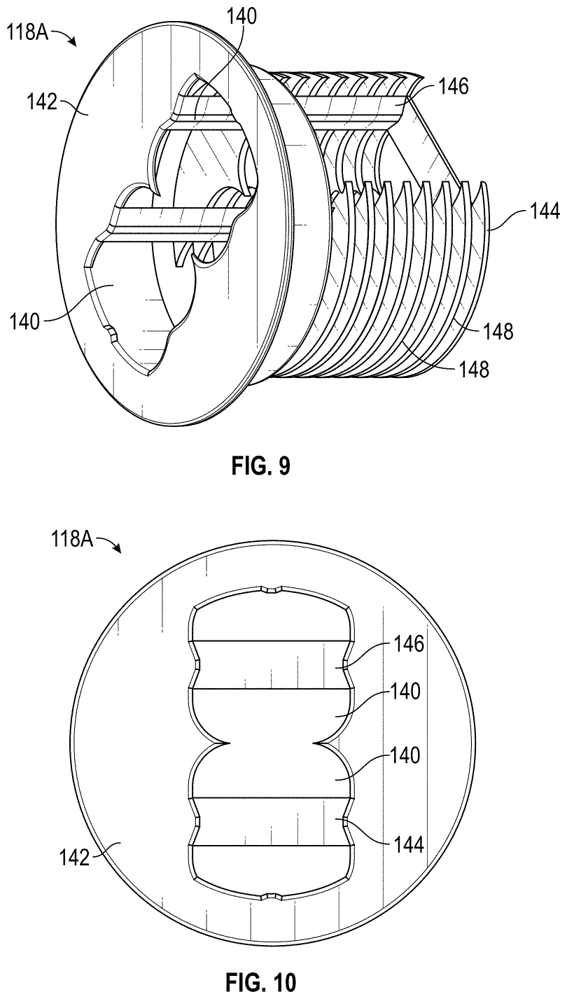

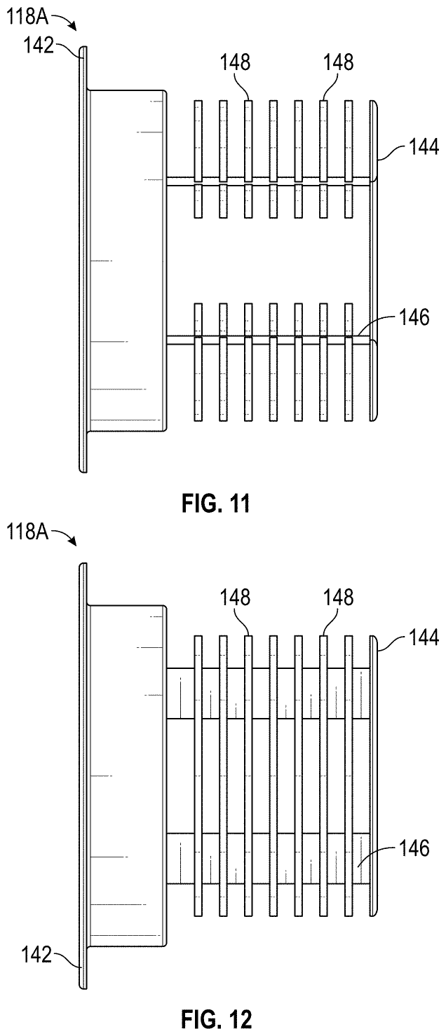

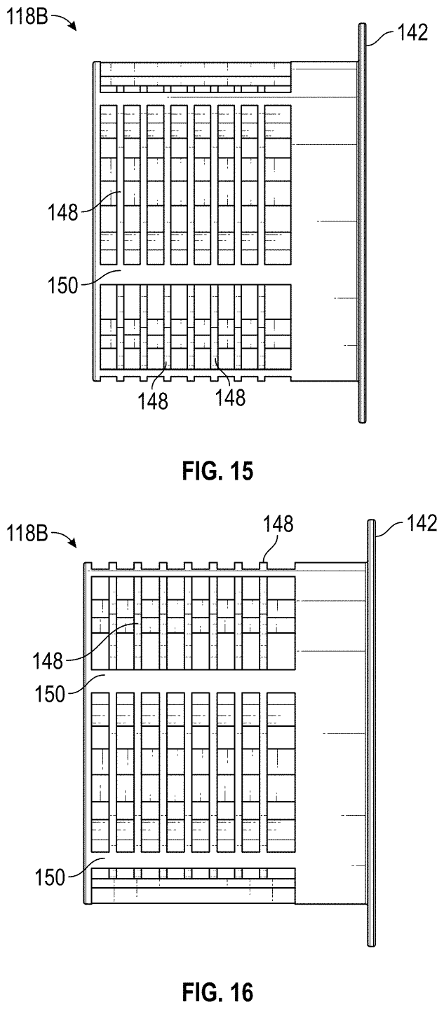

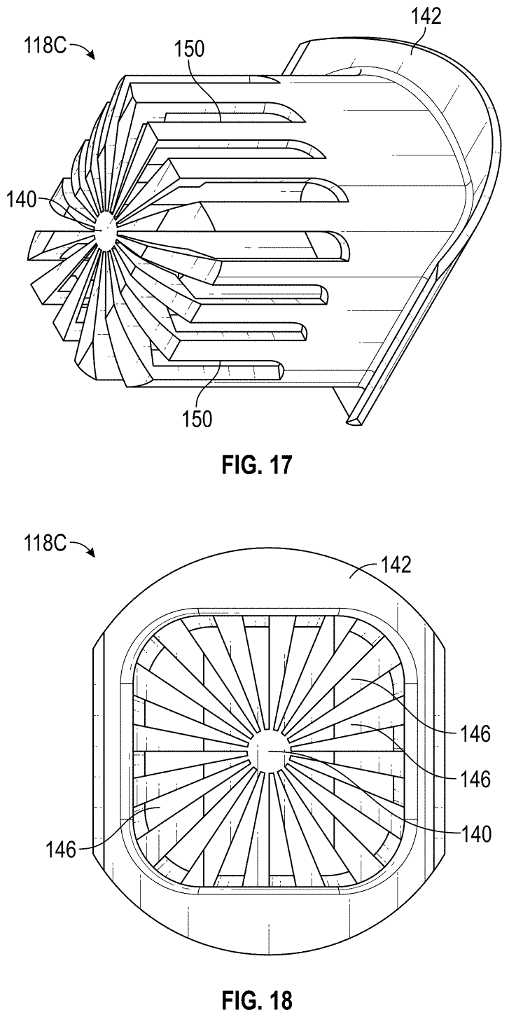

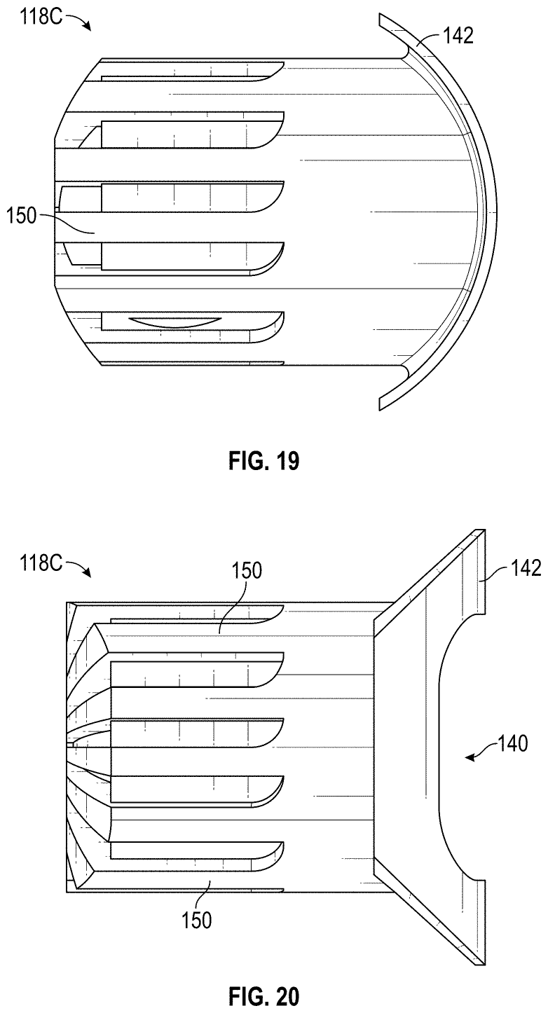

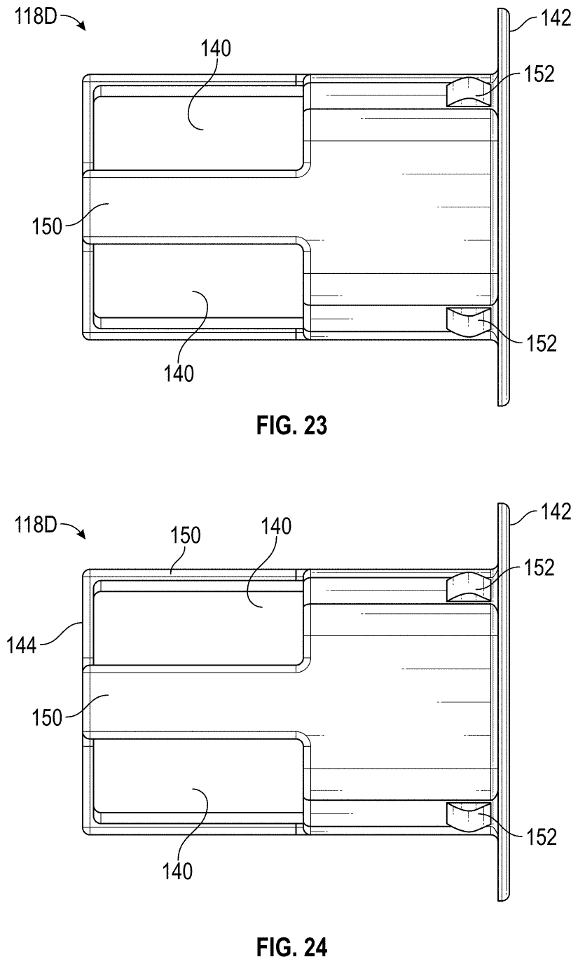

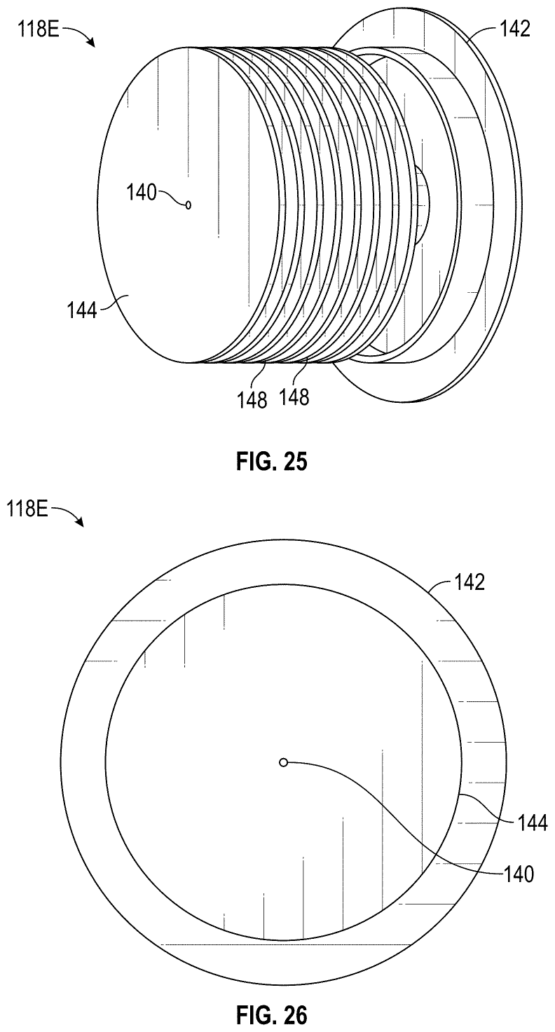

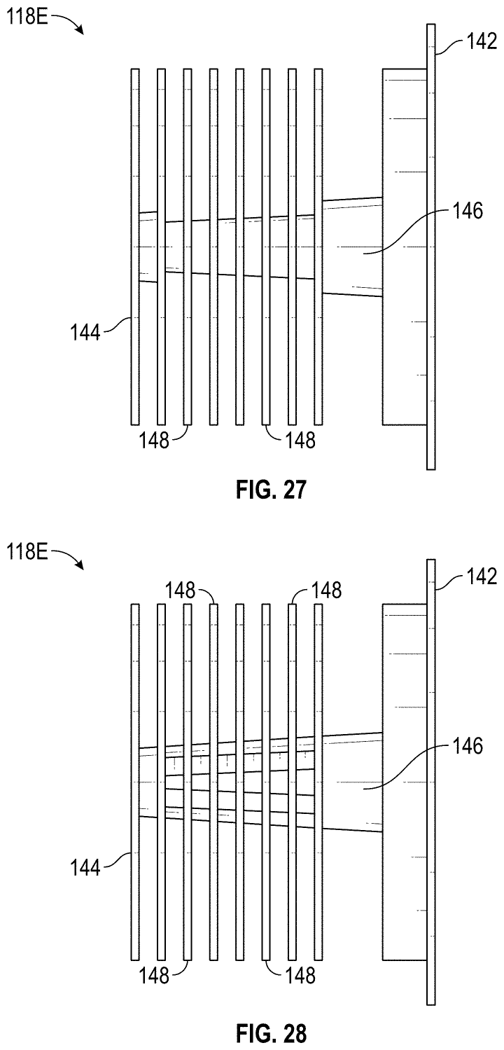

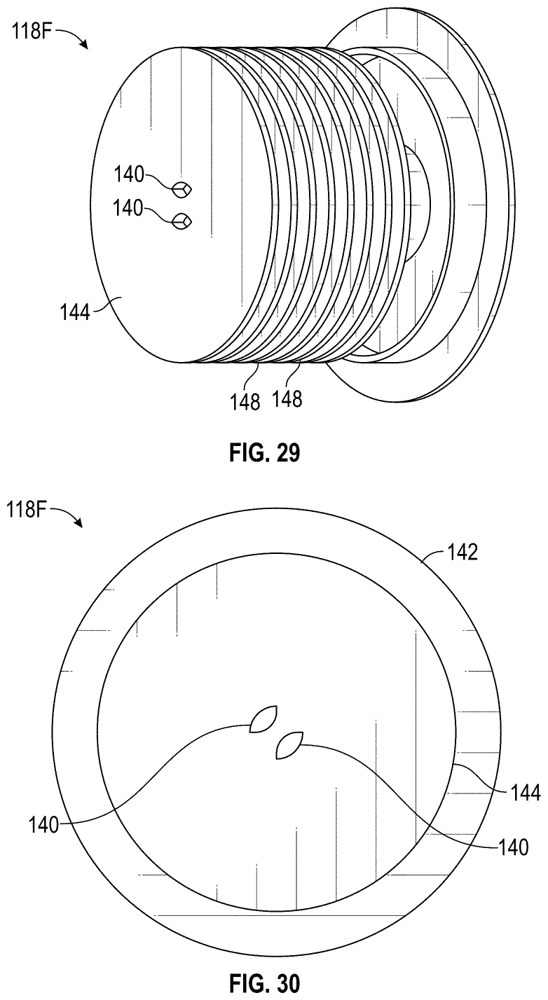

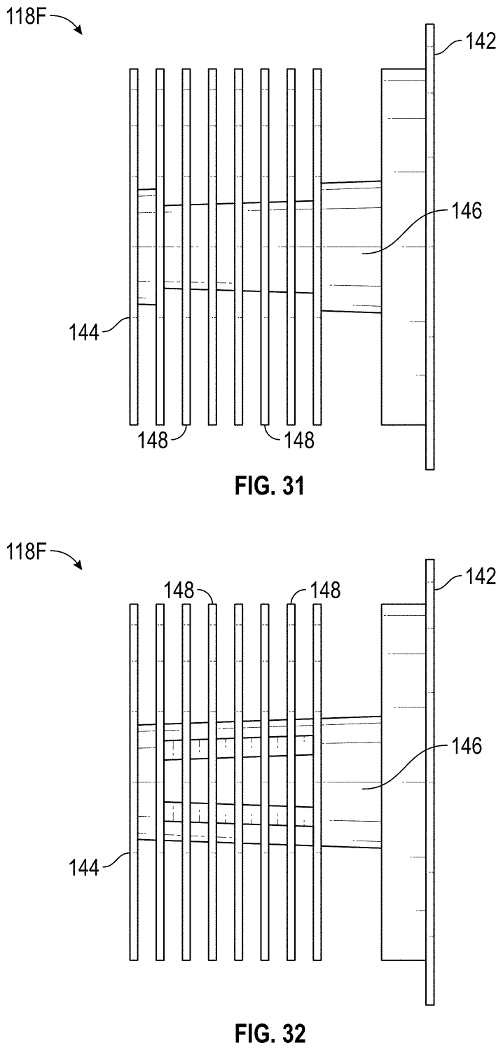

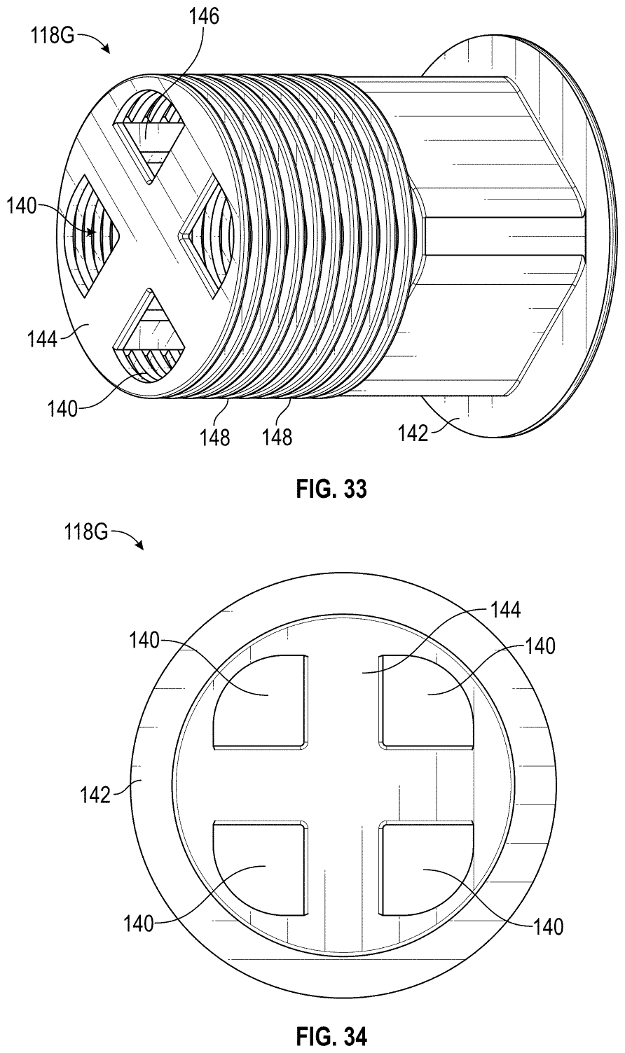

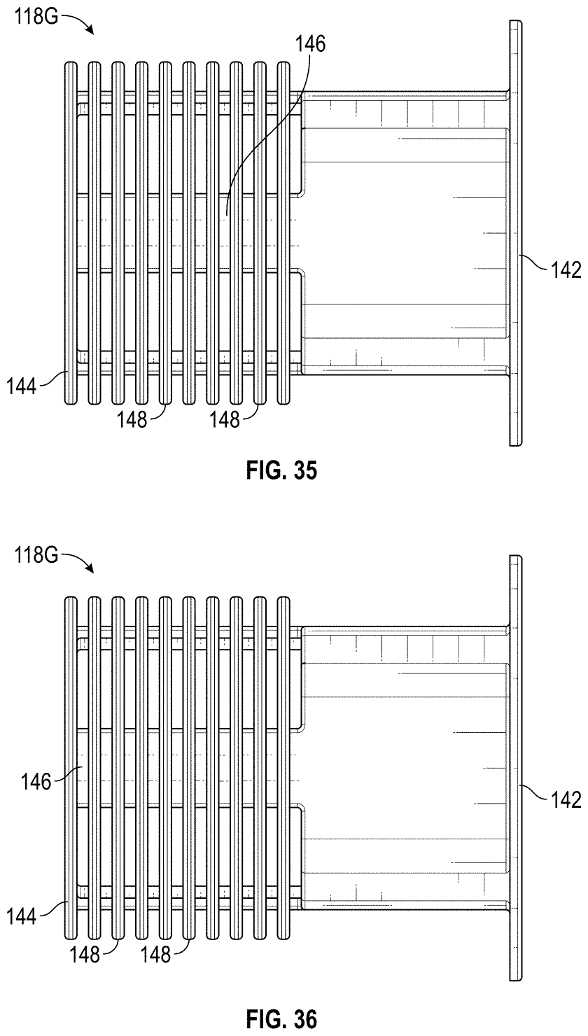

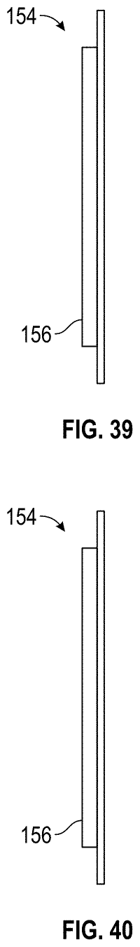

Because roots from plants grown within the modular growing system 100 can be substantially more voluminous than plants that grow outdoors, it can be critical that the root chamber 100B be sized large enough to accommodate for the increased volume that the roots will take up. For example, the seedling bay floor 132 and ground level surface of the seedling bay 134 should have adequate clearance between one another. In other words, seedling bay support structures 136 connect the two surfaces 132, 134 while spacing same far enough apart to accommodate growing roots therewithin. Moreover, the seedling bay apertures 138 are preferably spread out enough to allow for some horizontal spread of roots contained just below the ground level surface 134. The density of the seedling bay apertures 138 will depend on the type of plant being grown, the amount of time for which the user intends to grow the plant, and the particular configuration of the structural base(s) 118 being used. Specific embodiments of potential structural bases 118 are discussed with reference to FIGS. 9-40, infra.

The design shown in the figures utilizes four, corner support beams 112 for adequate support of the overall structure of the modular growing system 100. The support beams 112 are load-bearing pillars that support the weight of the modular growing system 100 and all of its components. The placement of the support beams 112 along the periphery of the modular growing system 100 creates a more stable system overall. Ideally, the load(s) exerted on the support beams 112 travel parallel to a longitudinal axis running through the support beam 112. The support beams 112 are themselves parallel to one another. The support beams 112 attach the basket 102 to the root chamber planks 110 and are also attached to upper, growth chamber planks 114, which form part of the growth chamber 100A.

The support beams 112 can also include notches or channels that allow for the insertion of transparent panels 120 enclosing the growth chamber 100A. The transparent panels 120 are preferably acrylic, though traditional glass and other suitable transparent materials can also be used. The transparent panels 120 help isolate growing plants from external environmental factors, such as animals, insects, and microorganisms. The shapes and sizes of the front panel 120A, rear panel 120B, and side panels 120C can vary depending on application. That said, for ease of manufacturability and mechanical design, these panels 120 are typically rectangular.

The water reservoir 122 stores non-potable water for use in agriculture. In both developing countries and some developed countries found in tropical climates, there is a need to store potable drinking water during the dry season so that it can be recycled.

In a preferred embodiment, the frame of the modular growing system 100 incorporates a solid wood design, though other suitable materials can be used to form the frame of the modular growing system if the circumstances warrant. The modular growing system 100 comes in floor and countertop models. The floor model was designed to meet the needs of academic and commercial groups and offers bi-level production of peppers, tomatoes, and blueberries in the top bay while leafy greens, squash, and herbs are grown in the bottom bay. The countertop model was designed with a homeowner in mind and offers three grow tubes with nine pod ports in the top bay and twenty-seven pod ports in the bottom bay. The models can operate on a proprietary 10:50 hydro: aeroponic principal which (a) focuses carbon fixation in stems, leaves, flowers, and fruits and (b) greatly reduces energy consumption.

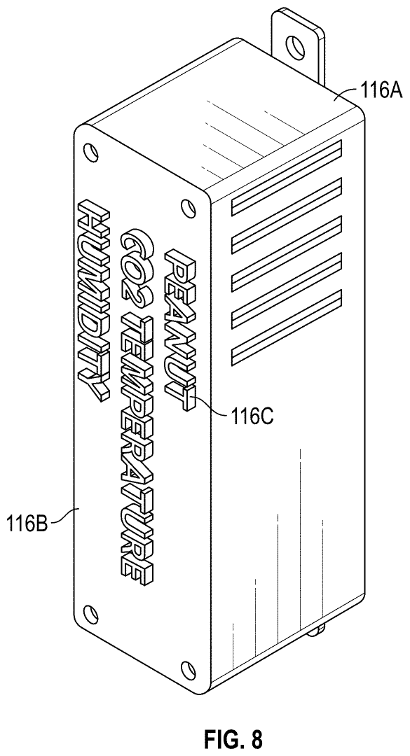

The growth chamber 100A includes a sensor 116. The sensor 116 is preferably used to accurately log CO₂ content, temperature, and relative humidity in the air. The sensor 116 of FIG. 8 includes a casing 116A, lid 116B, and embossed text 116C identifying a source of origin and the type of sensor. Sensors capable of sensing different and/or additional characteristics can be used in lieu of the sensor shown throughout the figures.

Depending on the plants intended to be grown within the growth chamber 100A, many additional features to help facilitate growth of plants can also be included. For example, the growth chamber 100A can further comprise: (a) programmable lighting with broad-spectrum lighting 128 and narrow-spectrum (red-blue) lighting 130; micro-fans that permit airflow into the growth chamber 100A; heating and cooling elements; and a micro-injector for introducing more CO₂ into the air.

The germination chamber 100C also includes programmable lighting with both narrow-spectrum (red-blue) lighting 130 and broad-spectrum lighting 128. The broad-spectrum lighting 130 can, as an example, comprise a 12V white (6500K) LED light strip. The narrow-spectrum lighting 130 can, as an example, comprise a 12V 1 blue (5500K); 6 red (3200K) LED light strip. Said lighting 128, 130 can be programmed, at least in part, by the hardware of the control box 124.

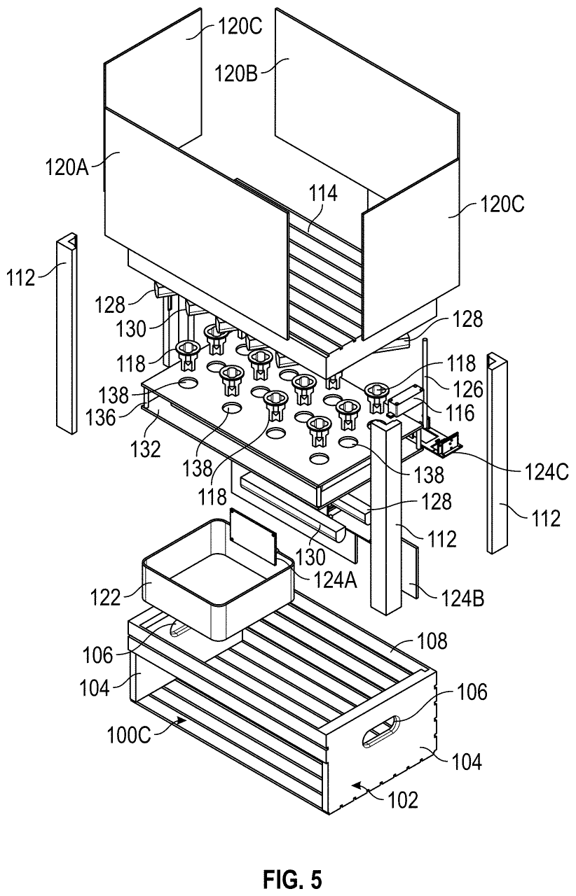

Aspects of the control box 124 are shown best in FIGS. 5-7 and 45-46, discussed infra. FIGS. 5-7 show the control box 124 comprising a lid 124A, a back plate 124B, an inner shelf 124C, and an outer casing 124D. The control box 124 is responsible for controlling and monitoring instruments within the modular growing system 100. The control box 124 is an enclosed unit that is the part of a system that users can access if needed. Power to the control box 124 can be delivered by way of electrical cable 126. The electrical cable 126 assembles one or more electrical conductors, usually held together with an overall sheath, and is used for transmission of electrical power. The electrical cable 126 can be installed as permanent wiring toward the rear of the growth chamber 100A.

Optionally, the germination chamber 100C, the root chamber 100B, and/or the growth chamber 100A can be heated or cooled with heating and cooling elements. One or more of these chambers can also be equipped with a 8 mp (HD) RGB camera that has Wi-Fi and motion detection capabilities. Cameras are useful to monitor growth of plants within the modular growing system 100.

FIGS. 9-36 show seven distinct embodiments of the structural base 118. The structural material forming the base can be, but is not limited to, metals, glasses, elastomers, thermoplastics, and/or thermosetting polymers. Where the bases 118 are made from thermoplastics or thermosetting polymers, the bases 118 are preferably manufactured by injection molding. Injection molding can present a significant advantage to the resulting product for purposes of mass-manufacture and durability.

The base 118 can be designed so as to fit any size hole of an irrigation pipe but are typically designed to fit one and three quarters (1¾), two-, three-, four-, and six-inch holes. The internal dimensions of the bases 118 are typically 33mm. This allows the bases 118 to fit one and one half-(1½) inch to two-inch growth media plugs 162.

The bases 118, which are placed within the seedling bay apertures 138, include cavities 140 defined by a top surface 142, bottom surface 144, central vertical dividers 146, fins 148, and peripheral vertical dividers 150. The top surface 142 is designed to but up against the irrigation pipe so as to stabilize the plant as it grows. The top surface 142 is preferably opaque to prevent light penetration into the irrigation pipe.

The ideal geometry of the irrigation pipe heavily varies depending on the plant being grown within the base 118. The “skirt” of the base 118 is designed to fit flat and curved irrigation pipes for stabilization. The central vertical divers 146 and peripheral vertical dividers 150 are employed to make the irrigation pipe more durable.

Many of these embodiments have horizontal fins 148, which provide lateral root structure, aeration, and optimal moisture retention during plant growth. In other words, the fins 148 are surfaces that extend from the base(s) 118 to increase the rate of heat transfer, aeration, etc. to or from the environment. Adding a fin to an object increases the surface area and can sometimes be an economical solution to heat transfer and moisture problems.

The bases 118A and 118B of FIGS. 9-12 and 13-16 are designed to accommodate up to three growth media plugs 162. The bases 118A, 118B effectively allow for more plant density per area.

More particularly, FIGS. 9-12 show a base 118A with a cavity 140 capable of receiving two growth media plugs 162 at once. The hole in the top surface 142 leading to the cavity is substantially bowtie shaped. The top surface 142 is symmetrical about both a horizontal axis separating the top plug portion of the cavity from the lower plug portion of the cavity. The top surface 142 is also symmetrical about a vertical axis that forms a perpendicular angle to the horizontal axis. The two-hole base 118A further comprises two primary central dividers 146 that have fins 148 and a bottom surface 144. The bottom surface 144 is a pair of lower most fins that are directly connected to one another through a pair of horizontal supports. The top and bottom surfaces 142, 144 are substantially planar. The fins 148 of the base 118A can be semicircular shaped and extend externally from said central vertical dividers 146. The base 118A is designed such that each fin 148 has an opposing fin 148 within the same plane that extends from the other central vertical divider 146. It is envisioned that in some embodiments, the fins 148 may be staggered at alternating elevations such that there are no two-dimensional planes that contain all of more than one fin 148 (excluding the bottom surface 144).

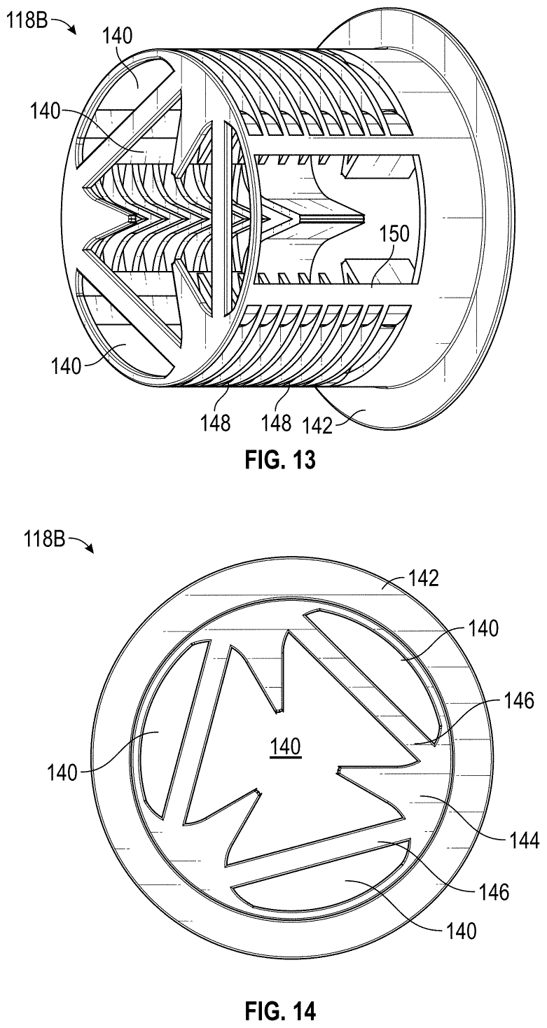

FIGS. 13-16 show a base 118B with a cavity 140 capable of receiving three growth media plugs 162 at once. The hole in the top surface 142 leading to the cavity is substantially tripod shaped. The tripod shape can be described as a triangle with diamond shaped cutouts at each of the three corners, or alternatively as an irregularly shaped six-pointed star. The three-hole type base 118B is similar to the two-hole base but includes small semicircular shaped openings toward the periphery of the top and bottom surfaces 142, 144.

The bases 118C, 118E, and 118F of FIGS. 17-20, 25-28, and 29-32 are designed to fit seeds greater than or equal to one millimeter. The bases 118C, 118E, and 118F of FIGS. 17-20, 25-28, and 29-32 are specially adapted to grow barley, oats, and peas, respectively. These embodiments eliminate the need for growth media plugs 162.

The base 118C of FIGS. 17-20 in particular includes a non-planar top surface 142, vertical peripheral supports 150 that turn somewhat horizontal (still non-planar) toward where a bottom surface would exist if there was one and co-terminate at a central circular opening leading to the cavity 140. Within the cavity, there exist a pair of two central vertical supports 146 thereby making the base 118C a little more durable.

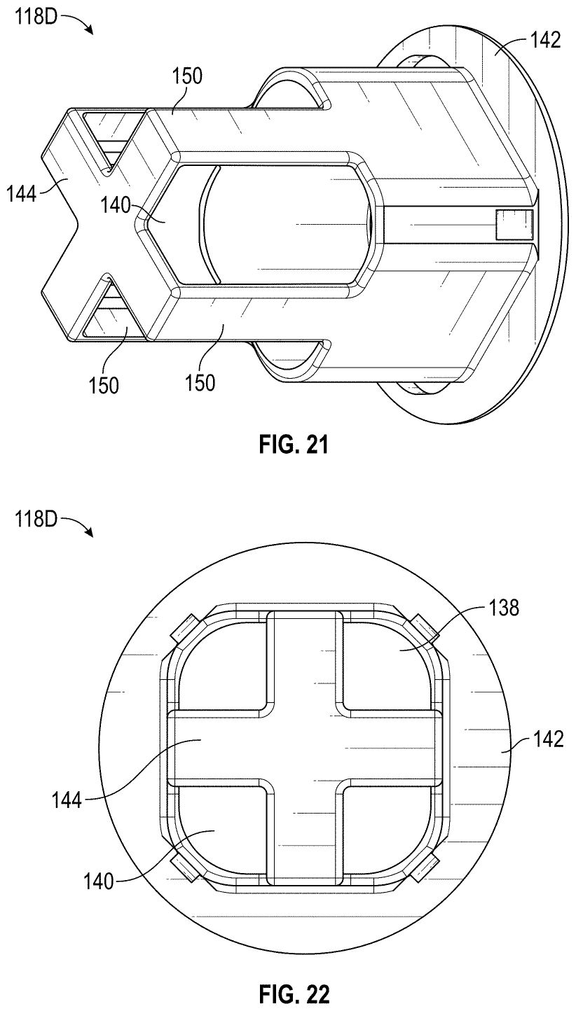

The bases 118D and 118G of FIGS. 21-24 and 33-36 have four symmetrically arrayed perforations exposing the base cavity 140. The shape of the cavity itself can be rectangular, as it is with base 118D, or cylindrical, as it is with the base 118G.

The base 118D utilizes four peripheral vertical supports 150 to create said perforations. The portion of the base 118D where the top surface 142 abuts the rest of the base 118D can be further reinforced with clips 152 to enhance stability of plants grown within the base 118D.

The base 118G utilizes fins 148 and a cross shaped bottom surface 144 having a circular outer boundary that extend from a central vertical divider 146. The perforations are thus caused by the openings that exist between the cross and the outer circular. The fins 148 contain similar perforations and are layered so that each of the perforations line up and the cavity 140 thus appears to be symmetrically arrayed columns.

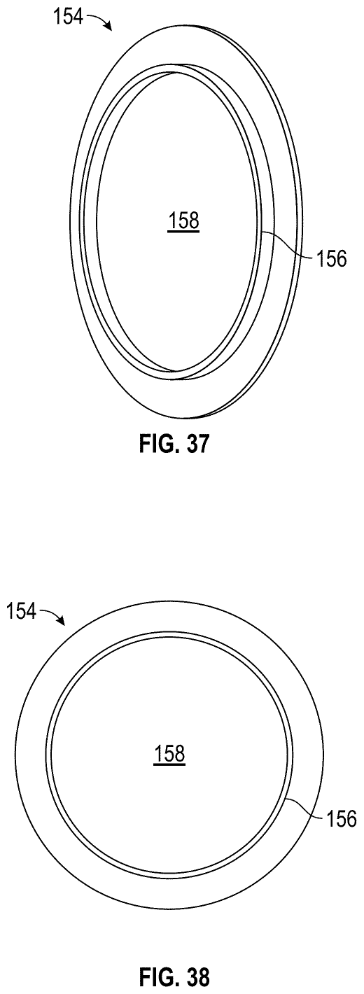

The bases 118 come with a cap 154 prevent light penetration in holes. An example of a cap 154 is shown in FIGS. 37-40. The cap shown includes a flange 156 and a circular cavity 158.

The flange 156 is a protruded ridge, lip or rim, either external or internal, that serves to increase strength of the cap 154. The flange 154 also helps easy attachment/transfer of contact force with the seedling bay, via seedling bay apertures 138. The circular cavity 158 receives the main portion of the structure of the aforementioned bases 118. The circular geometry for the cavity 158 can be used with most bases 118. However, other geometries for the cavity 158, such as a rectangle, can be preferred or even required for securing a snug fit with some specific embodiments of the base 118, e.g., the base 118D of FIGS. 21-24.

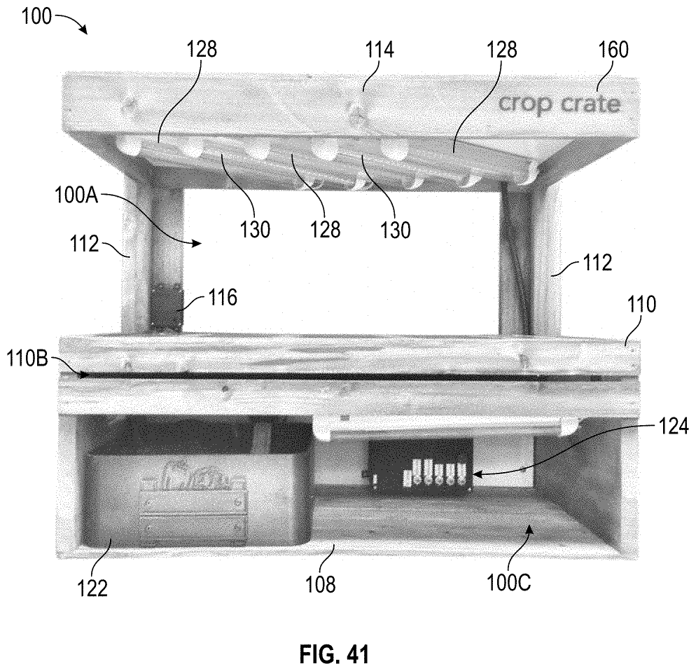

FIGS. 41-45 show photographs that capture images of a non-limiting example of the modular growing system 100 described above.

The photograph of FIG. 41 emphasizes three full spectrum (white) lights 128, two narrow-spectrum (purple) lights 130, left and right support beams 112, an electrical cable 126, a CO₂, temperature, and relatively humidity sensor 116, growth chamber 100A, germination chamber 100C, and water reservoir 112. The modular growing system 100 can also include a source identifier 160, so that consumers and students can more easily distinguish between quality products and counterfeit growing systems.

A kit incorporating the modular growing system 100 can be shipped with: said modular growing system 100, twelve (can be distinct, identical, or a combination thereof) structural bases 118 for plant roots, twelve caps 154 that correspond to said bases 118, twelve plugs 162 that correspond to said bases 118, a container 166 (e.g., a germination tray), seed, a 3:1:5 nutrient solution for facilitating growth of plants 164 within the plugs 162, and an access point with a power supply. The germination tray, a.k.a. a seed starting tray, acts as a gardening tool specifically designed to hold multiple seeds, starting from the germination stage, until the seedlings are ready for transplantation. Some germination trays can come with a dome to help maximize humidity levels, and some can come with heating pads that help speed up germination rates.

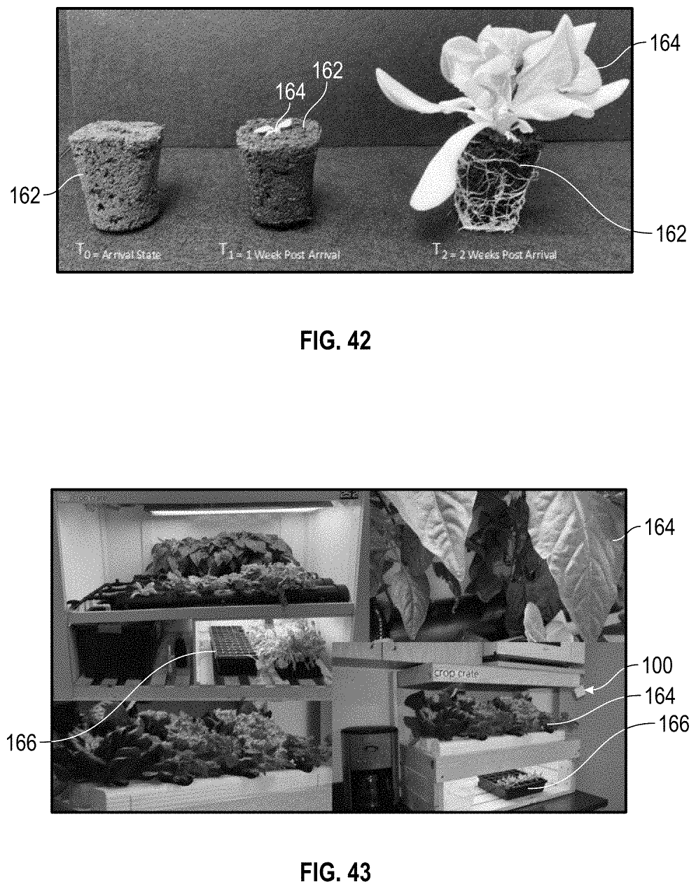

The photograph of FIG. 42 emphasizes details of the plug 162 and plants 164 that grow within the plug 162. In FIG. 42, a plug 162 in its arrival state (i.e., To, left-side), a plug 162 one week after arrival (i.e., T₁, middle), and a plug 162 two weeks after arrival (i.e., T₃, right-side).

The plug 162 is typically a cylinder of medium in which a plant is grown. The medium is generally held intact by roots of the plant 164. For example, the plugs 162 can include small-sized seedlings grown filled with potting soil that can be grown in seed trays. This type of plugs 162 can be used for commercially raising vegetables and bedding plants. Other plugs 162 can include young plants raised in small, individual cells, that are ready to be transplanted into containers or a garden. Professionally raised vegetable/flowering plants in controlled conditions during their important formative period (the first four-six weeks) can help to ensure plant health in instances where transporting the plant before such a time may have adverse effects on the plant. Plugs 162 can also be used to ensure plants 164 reach their maximum potential during the harvest/blooming period, as establishing a garden using plugs 162 is often easier than doing so starting from seed.

The organic seed plugs 162 contain key symbiotic bacteria and micronutrients. The plugs 162 are developed for seed distribution and optimal growth within the modular indoor growing system 100. Plugs 162 are specifically designed for each crop based on symbiosis and nutrient requirements. The plugs 162 utilize a peat moss compost constructed for an optimal air-to-water ratio. The plugs 162 are fortified with key nutrients that provide favorable growth characteristics from seed to harvest.

Exemplary nutrients within the plug 162 can include, but are not limited to, the use of approximately: Nitrogen (12% N), Phosphate (7% P₂O₅), Potash (10% K₂O), Magnesium (1% Mg), Sulfur (5% S), Boron (0.02% B), Iron (0.03% Fe), Manganese (0.05% Mn), Molybdenum (0.02% Mo), and Zinc (0.05% Zn), in the growth media. Substrates can also made be from Peat Moss, Rhassoul Clay, and agar colonized by Glomus intradices, G. mosseae, G. aggregatum, G. etunicatum, Trichoderma harzianum, Pseudomonas, Isosphaera, Pirellula, Acidothermus, Pseudolabrys, Singusphaera, and Bacillus sp. are being tested to provide a more sustainable matrix over peat moss. Pseudomonas strains IZC-RBcr4 and IAC-RBru1 can increase lettuce biomass yields up to 30%, while Bacillus strains have shown to increase plant growth in medicinal plants like basil by the emissions of volatile organic compounds. Data from internal and external plant-microbe-substrate interaction experiments will be processed by artificial intelligence to build a highly optimized pod for plant growth and flavor further enhancing the modular growing system 100 experience.

The photograph of FIG. 43 emphasizes an assortment of apparatuses described with reference to the aforementioned kit and results from using same. The photograph captures a modular growing system 100, plants 164 grown indoors, containers 166 for storing and/or germinating said plants 164.

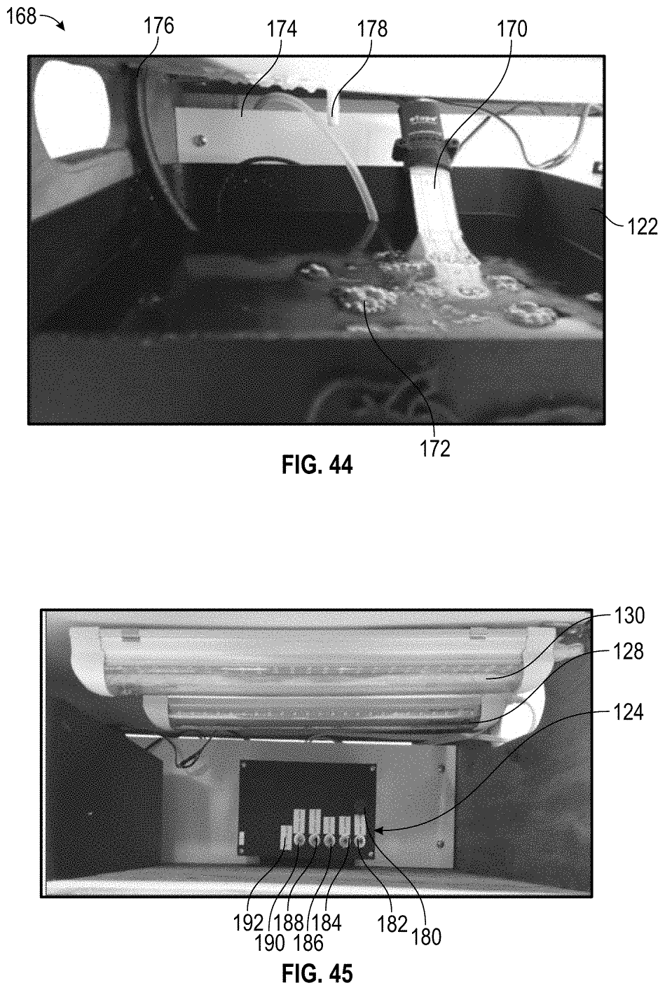

The photograph of FIG. 44 emphasizes details of an irrigation system 168 that heavily relies upon the water reservoir 122. Storing water invites a host of potential issues regardless of the intended purpose. The water can be contaminated through both organic and inorganic means. Thus, the proper selection of components in the irrigation system 168 can be critical in avoiding these issues. As shown in the figures, an example irrigation system 168 includes a water level sensor 170, aerator stone 172, water pump 174, hose 176, and a growth chamber water return 178.

The water level sensor 170 detects the level of water within the reservoir 122. The level measurement can be either continuous or point level. Continuous level sensors measure level within a specified range and determine the exact amount of substance in a certain place, while point-level sensors only indicate whether the substance is above or below the sensing point. Generally, the latter is used to detects levels that are excessively high or low.

The aerator stone 172 facilitates aeration of water within the reservoir 122. Aeration of the water is achieved by passing air through the liquid. The aerator stone 172 can be a porous block. Ceramics are suitable for this purpose, often involving dispersion of fine air or gas bubbles through the porous ceramic into a liquid. The smaller the bubbles, the more gas is exposed to the liquid increasing the gas transfer efficiency. Diffusers or spargers can also be designed into the system to cause turbulence or mixing if desired. In some embodiments, the aerator stone 172 operates only at scheduled times, and in other embodiments, operates near continuously.

The water pump 174 is a device that moves water throughout the irrigation system 168 through mechanical action. A suitable water pump for these purposes can thus be employed. For example, the type of water pump used can be selected from the group consisting of: direct lift, displacement, and gravity. The water pump 174 typically operates by a reciprocating or rotary mechanism and consumes energy to perform mechanical work to move the water.

The hose 176 can be a flexible hollow tube designed to carry fluids from one location to another. The design of the hose 176 is based on a combination of application and performance. Common factors are size, pressure rating, weight, length, straight hose or coilhose, and chemical compatibility. Most hoses 176 employ nylon, polyurethane, polyethylene, PVC, or synthetic or natural rubbers, based on the environment and pressure rating needed. The hose 176 can also be manufactured from special grades of polyethylene (LDPE and especially LLDPE), PTFE (Teflon), stainless steel, and other metals. Pipe(s) and other fluid connectors can also be used in lieu of the hose 176, where circumstances permit.

The growth chamber water return 178 allows water to return from the growth chamber to the reservoir 122 where the water can oxidized by the aerator stone 174. The return flow can comprise surface and subsurface water that leaves the growth chamber 100C following application of irrigation water. The use of this water return 198 not only enhances recyclability, but also helps mitigate problems with excess moisture in what would otherwise be a problematic area for the modular growing system 100. Optionally, the growth chamber water return 178 can return water to the reservoir 122 after said water has passed through one or more filtration devices.

When ground water is extracted for irrigation and other uses, it is to be appreciated some of the water shall be lost by the time it is returned to the return flow. In other words, the water cycle of the modular growing system 100 is not perfect. For example, water can evaporate, be lost to soil within the root chamber 100C, or be lost to plants within the growth chamber 100C. As a result, the water reservoir 122 may have to be periodically refilled to account for such losses.

The water reservoir 122 optimally: (a) holds approximately seven liters of water; (b) is designed for consistent and uniform aeration of the water; (c) has built in temperature and water level monitoring; and (d) can be heated or cooled with key elements.

The photograph of FIG. 45 emphasizes details of the control box 124, which includes a fuse 180, water pump switch 182, upper narrow-spectrum light switch 184, upper full spectrum light switch 186, lower narrow-spectrum light switch 188, lower narrow-spectrum light switch 190, and production number 192.

The fuse 180 acts as an electrical safety device that operates to provide overcurrent protection of the electrical circuit within control box 124. The fuse 180 comprises a metal wire or strip that melts when too much current flows through it, thereby stopping or interrupting the current. The fuse 180 is a one-time use device; once the fuse 180 has operated it is an open circuit, and must be replaced or rewired, depending on its type.

The switches 182, 184, 186, 188, 190 are electrical components that can disconnect or connect the conducting path in an electrical circuit, interrupting the electric current or diverting it from one conductor to another. For example, these switches 182, 184, 186, 188, 190 can be an electromechanical device consisting of one or more sets of movable electrical contacts connected to external circuits.

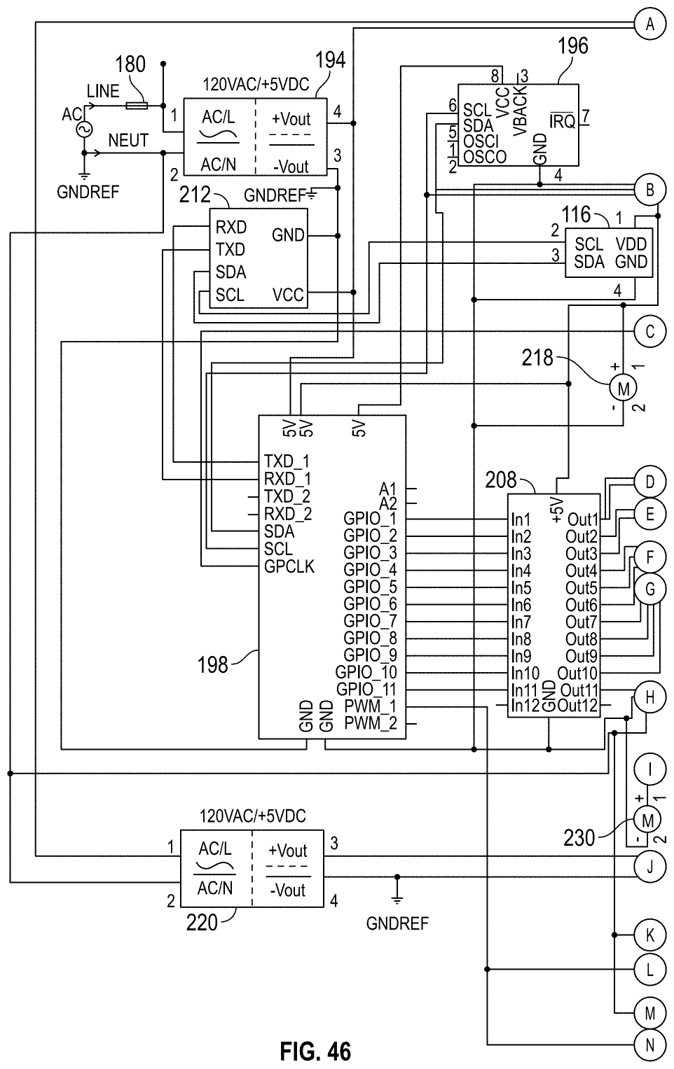

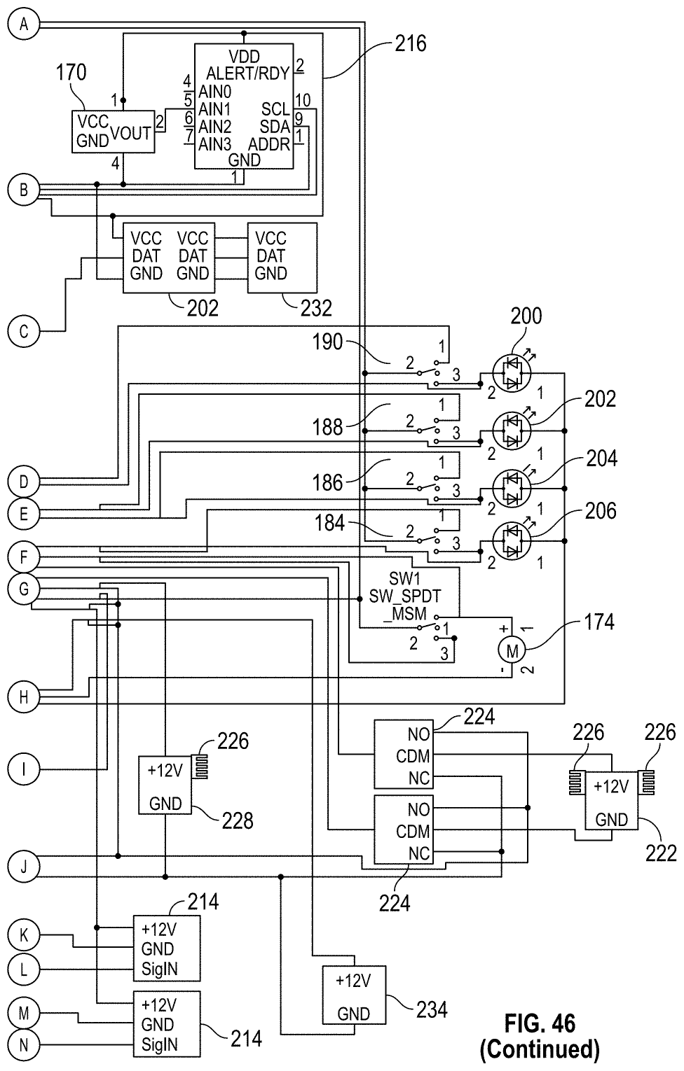

FIG. 46 is a simplified wiring diagram that illustrates a potential layout for electrical components within the modular growing system 100, including those electrical components located within the control box 124.

In the non-limiting example shown, all electronic hardware is powered by a 5V AC/DC converter 194. A real time clock 196 is powered using 3V power received pins on a system on a chip (“SOC”) 198. All LED grow lights, including bottom white LED lights (full spectrum) 200, bottom purple LED lights 202, top white LED lights (full spectrum) 204, and top purple LED lights 206, are powered by 120VAC from a wall outlet.

The real time clock 196 is used to communicate with the SOC 198 for it to turn the lighting 200, 202, 204, 208 and watering on and off at the specified time given by the user via an online server. The real time clock 196 can communicate through a communication protocol, such as the I2C protocol.

The SOC 198 is an integrated circuit capable of integrating all or most electrical components of the modular growing system 100. The SOC 198 can contain digital, analog, mixed-signal, radio frequency signal processing functions, and even USB connectivity. The SOC 198 includes many hardware components, such as a central processing unit (CPU), memory, secondary storage, input/output ports, radio modems, and a graphics processing unit (GPU)—all on a single substrate or microchip. As a result, the use of SOC 198 over a more common traditional motherboard-based PC architecture can be particularly beneficial where the number of parts is desirably less, as traditional motherboard-based PC architectures separate components based on function and are required to connect them through a central interfacing circuit board. This is because more tightly integrated computer system designs improve performance and reduce power consumption as well as semiconductor die area than multi-chip designs with equivalent functionality. However, special circumstances could warrant the use of the traditional motherboard-based PC architecture within the modular growing system 100, such as those where replaceability of components is highly desirable.

In a preferred embodiment, the SOC 198 is embedded with a wifi module, a computer processing unit (“CPU”) having RAM, and a micro secure digital (“SD”) memory. The SOC 198 and its components allow for data collection and communication between online server(s) and the sensors and control (e.g. sensor 116, control box 124) of the modular growing system 100. The SOC 198 can control a lighting and watering schedule of the modular growing system 100 when in automatic mode through the online server(s). The SOC 198 itself is controlled by an 8-block relay board 208 that is driven by outputs on the SOC.

Auto, off, and on/manual modes of the control box 124 are controlled using a dual pole-triple throw switch 210 to direct power to either the common of the respective relay block 208, directly energize the load in manual mode, or turn the load off in the off position.

A sensor 116 capable of sensing CO₂, temperature, and relative humidity is used to log data into the online server and communicates with the SOC 198 via a communication protocol, such as I2C protocol, that is then turned into a TX/RX signal using a serial communication port 212 to enable clock stretching. Air can be pulled through the sensor casing 116A using a 5V fan for more accurate sensor readings.

In the preferred embodiment, the water level within the reservoir 122 is measured using a resistance-based level sensor 170. The resistance-based level sensor 170 sends an electrical signal to an analog to digital converter (“ADC”) 216, which enables communication between the resistance-based level sensor 170 and the SOC 198. A 5V DC water pump 174 is used to move water from the reservoir 122 to the growth chamber 100A, and to and from an aerator used in the water reservoir 122. The aerator comprises an aerator motor 230 and an aerator stone 172. The aerator is connected directly to the 5V output of the AC/DC converter 194. Thus, the aerator can remain on as long as the modular growing system 100 is plugged into an electrical outlet (e.g. wall outlet).

Optionally, an additional AC/DC converter 220 can be added to power on additional components, such as a heating/cooling element 222 in the growth chamber 100A, coupled relay outputs 224, a heating/cooling element 228 in a water chiller, a chiller water pump 230, a waterproof water temperature sensor 232, and a motor control valve 234.

The cooling/heating element 222 can be a 12V cooling/heating element and can be used to regulate the temperature the plants 164 are exposed to. The cooling/heating element 222 can be driven by the two coupled relay outputs 224 that determine current direction through the component, which can determine whether the cooling/heating element 222 is pulling heat out of the system or adding heat into the system. Two heat sinks 226 can be added to the two sides of the cooling/heating element 222 with fans to dissipate heat. The temperature can be automated by using a proportional-integral-derivative (“PID”) time proportional control (“TPC”), based on the user's desired temperature setpoint. The setpoint can be manually selected by the user through the online server.

A 12V cooling element 228 (a.k.a. the “chiller”) can be added to control the water temperature in the reservoir 122. The chiller can utilize a second 5V DC pump, a.k.a. chiller water pump 230, to circulate water through the chiller 228. The chiller 228 can be energized via a relay output, which can be automated using PID TPC based on the users desired water temperature setpoint. The setpoint can be manually selected by the user via the online server.

A 5V waterproof temperature sensor 232 can be added to the water reservoir 122 to monitor the water temperature. The waterproof temperature sensor 232 can communicate with the SOC 198 by sending an electrical signal to the ADC 216, which will send the actual temperature reading to a general purpose clock pin (GPCLK) on the SOC 198.

Two 12V variable speed fans 214 can be be added to the growth chamber to give the user control of air flow circulating around the plants 164 via setpoint selection in the online server. The variable speed can be controlled using a pulse width modulation (PWM) signal from the SOC 198. The signal can be received by electronic speed controllers (“ESCs”) which can then control the speed of the fans 214.

A 12V motor control valve 234 can be put in place to control CO₂ injection into the growth chamber 100A. The valve can be controlled via a relay output from the relay board 208.

### Setup and Use

The following examples are given only for proposes of enabling the invention and aspects found within the following examples are not limiting unless specifically claimed.

To assemble the modular growing system 100, the vertical support beams 112 should be unpacked and the left-side and right-side identified. On the side with the cables (which can be either the left-side or the right-side, depending on the embodiment), the support beam 112 should be attached with a fastener (e.g., a screw), to the upper panels 114 which include the light bank. This process should then be repeated with the remaining support beam 112 on the opposite side. The basket 102 and/or can then be attached to the support beams 112 via remaining fasteners to complete construction of the overall frame of the modular growing system 100. If the basket 102 is not preassembled, germination planks 108 may have to be fastened to one another and to the sidewalls 104 prior to being attached to support beams 112. The CO₂, temperature, and relative humidity sensor 116 can then be attached to either the right or left light support beam 112 with additional fasteners (e.g. screws smaller than those used to fasten the support beams 112 to the upper panels 114). The tray

The water pump 174 can be plugged into the control box 124 by way of pump-plug-in access point in the left side of the tray. Whether the pump wire is directly connected to the control box near a link labeled “water pump” should first be verified. If not, the two wires should be connected. Similarly, the pump's tubing and the tray's connection on the left side of the modular growing system 100 should be checked to determine whether they are already connected. If they are not connected, the connection can be secured by applying pressure in a small circular movement until most of the ridge of the tray is almost covered.

The modular growing system 100 should can then be plugged into a wall outlet (e.g., 120 AC), and an LED indicating the power is on should come on. If such an indication of power does not occur, the reset button should be pressed.

The water reservoir 122 should be filled with water until the water reaches a water level of about 1 centimeter (cm) below the top edge of the water reservoir 122.

In the germination chamber 100C, the control box 124 allows for different lights to be manually controlled by a user depending on position of the switches 182, 184, 186, 188, 190. For automated control of one or more lights 128, 130, the user must ensure the switches 182, 184, 186, 188, 190 are flipped into an upward position (auto).

To setup a wireless connection (e.g., Wi-Fi) for the modular growing system 100, the user can be directed to a hyperlink at which each installation files can be downloaded and stored within a single folder. After being downloaded, an access point/Wi-Fi module of the modular growing system 100 should be plugged into a wall outlet. The Wi-Fi module should automatically broadcast a local network after waiting about a minute. This network can be named anything that can be easily understood by the user (such as “cropcrate”) to be associated with the modular growing system 100. A non-transitory computer readable medium should then be used to connect to the broadcasted Wi-Fi network. Thereafter, the downloaded installation executable (i.e., “.exe” type file) can be run on the non-transitory computer readable medium. Following a “connection successful” message, the executable can look for a specific file (e.g., a file having the name: CCPv1_U#, with number being varied amongst distinct modular growing systems 100. If the specific file is not located, the application should be closed, relaunched, and run again. If one or more specific files is located, the located files can then be presented to the user in a dropdown menu such that the user can select one or more of the identified files.

The user can then be given the option to send an email with his or her production number 192 identified, the user's preferred email address, and a password in order to setup access to an online portal. Once login credentials have been established, the access point can be unplugged, and the online portal still accessible via a standard web browser of the computerized device. The online portal should allow the user to manually change the light and watering schedule associated with specific unit name(s) of any modular growing systems 100 that have been properly connected. The lighting/watering schedule should default to a list of recommended settings. To change the settings, the user should be allowed to hit an “edit” button. A new window can appear, presenting the user with options for automation. For example, when the user is germinating plants, initial recommended settings might look like the following table in the popup window:

TABLE 1
Recommended Settings for Germination Stage

| | |
|---|---|
| Instances of watering each day | 0 |
| Pump time in seconds | 300 |
| top broad-spectrum lights | ON: 12 to OFF: 12 |
| operating from (hours) | |
| top narrow-spectrum lights | ON: 12 to OFF: 12 |
| operating from (hours) | |
| bottom broad-spectrum lights | ON: 12 to OFF: 20 |
| operating from (hours) | |
| bottom narrow-spectrum lights | ON: 8 to OFF: 20 |
| operating from (hours) | |
| upper temperature threshold | 100° F. |
| for notification email | |
| lower temperature threshold | 0° F. |
| for notification email | |
| lower relative humidity | 0 |
| percentage threshold for | |
| notification email | |

Changes can then be made to each automated setting in the popup window, and then saved. After changes have been saved, the user should verify the switches of the control box 124 are switched up in the auto position before leaving the proximity of the modular growing system 100. Prior to using the plugs 162, the plugs 162 should be moist. If the plugs 162 are dry, the plugs 162 can be soaked in water and any excess water squeezed out.

A layout where each crop is put within a container 166 (e.g., a germination tray) can be created. Two seeds can initially be added to each plug 162. The seeds can be planted at least one centimeter deep. The plugs 162 can then be added to the germination tray in the specified location. Approximately two centimeters of water should be added to the bottom of the germination tray. A clear dome can be placed on top of the germination tray and a top vent opened. This allows condensation to occur in the dome. The best scenario is light condensation on the sides of the dome.

The plugs 162 can then be placed in the germination chamber 100A in the crop crate. The light schedule can then be adjusted manually according to user preference. For example, four hours of narrow-spectrum (purple) light, followed by four hours of both broad (white) and narrow (purple) spectrum lights, followed by four hours of broad-spectrum (white) light, can yield positive results for many types of plants 164. After the plants 164 grow to be an inch tall or wide, the germination stage is finished. Attention must be kept to make sure the one centimeter of water does not dry up.

Thereafter, the plugs 162 can be removed from the cell germination container and inserted them into the root chamber 100B by way of the structural bases 118. The structural bases 118 can be inserted into the modular growing system 100 through seedling bay apertures 138.

Water should then be added to the water reservoir 122 to the appropriate level and the recommended amount of growth nutrient solution added to the reservoir 122. In this case, the amount can be one fourth (¼) of the supplied nutrients. One fourth (¼) of the solution can then be added every two weeks until it is completely depleted after eight weeks. The water pump 174 can then be turned on for five minutes to water the plants 164. This can be done by moving the switch on the pump down to the ON position. The switch can then be flipped back to the AUTO position after manual use. As the plants grow, increase the time of watering can for many plants be increased to up to ten minutes.

TABLE 2
Recommended Settings for Post Germination Stage

| | |
|---|---|
| Instances of watering each day | 2 |
| Pump time in seconds | 300 |
| top broad-spectrum lights | ON: 7 to OFF: 19 |
| operating from (hours) | |
| top narrow-spectrum lights | ON: 5 to OFF: 21 |
| operating from (hours) | |
| bottom broad-spectrum lights | ON: 12 to OFF: 12 |
| operating from (hours) | |
| bottom narrow-spectrum lights | ON: 12 to OFF: 12 |
| operating from (hours) | |
| upper temperature threshold | 100° F. |
| for notification email | |
| lower temperature threshold | 0° F. |
| for notification email | |
| lower relative humidity | 0 |
| percentage threshold for | |
| notification email | |

### Artificial Intelligence & Virtual Assistant

The modular growing system 100 is compatible with and utilizes heirloom seed from around the world, custom seed pods 162 containing symbiotic bacteria and essential nutrients, passport cards describing each heirloom seed accession, a countertop hydroponic grow crate equipped with microsensors and imaging systems, user-friendly mobile and web applications, and a highly personalized virtual assistant.

Using a graphical interface 236 that allows users to interface with a specialized virtual assistant, customers and students are able to set up a user account 250. Once they have a user account 250, the customers and students are then able to login 252 and purchase seed from an available accession list. The customer or student can select a plant variety based on type, size, and color from a drop-down menu. Once provided with a modular growing system 100 and some accessions, the customer completes the setup process outlined above which is facilitated by downloading a mobile application. Seed pods 162 placed in the seedling bay for two weeks. The mobile application can prompt the consumer using push notifications 258 to transfer the first nine pods 162 to the grow tubes. After two weeks, the app will prompt the consumer to harvest three of the accessions from the grow tubes and replace them with the next three accessions from the seedling bay. The cycle will continue aided by mobile app notifications and monthly seed/pod supplies under a plan. Such a plan can be created for educational or commercial purposes. Consumers and students are able to share their experiences with each accession in a simple nonintrusive manner through the mobile application or directly through the Wi-Fi module included with the modular growing system 100, which is linked to an augmented intelligence system. The augmented intelligence system automates the modular growing system 100 through virtual settings, monitors the system with an intelligent sensor 116, order materials from an associated seedbank, and collects data.

The modular growing system 100 can also use microsensors to measure ambient temperature along with water pH and levels as well as HD (1080p) RGB and RBP (NIR) cameras to monitor plant health and growth. The overall system components can be controlled by a computing software that processes data from the microsensors and cameras in real-time and uploads it to a database associated with eh modular growing system 100 for downstream analytics and notifications via a mobile application.

The database consists of crowd sourced crop attributes (agronomic, processing, and hedonic), internal crop attributes, and DNA/metabolomic data. Data from the database will be used to calculate imputation models, develop new varieties, and build consumer intelligence via a virtual assistant neural net. The neural net will facilitate costumer-based selection of accessions and development of new varieties through virtual parental evaluation using simulated progeny. In addition, the neural net will use the information to discover underlying genetic mechanisms controlling key attributes. This data will be used to develop molecular assays to predict key traits and provide target for gene editing. As an example, the collected data could relate to lettuce (Lactuca sativa), basil (Ocimum sp.), pepper (Capsicum sp.), squash (Cucurbita sp.), tomato (Solanum sp.), strawberry (Fragaria x ananassa), blueberry (Vaccinium corymbosum), and raspberry (Rubus idaeus), as well as other accessions from around the globe.

The genome from each line can be sequenced and DNA fingerprints can be developed for each line. Key trait data expressed in the field can be assembled using a novel text mining approach for a portion of the accessions. The DNA and trait information can be processed into a neural net and automated commends for selecting and assessing training and validation sets in the modular growing system environment. Based on internal assessments, automated methods can be used to select seed and passport descriptors, such as: variety name, collection date and site, plant type, suggested uses, and key attributes. Certified pure line seed from single plants of each accession in the collection are producible for distribution and curation.

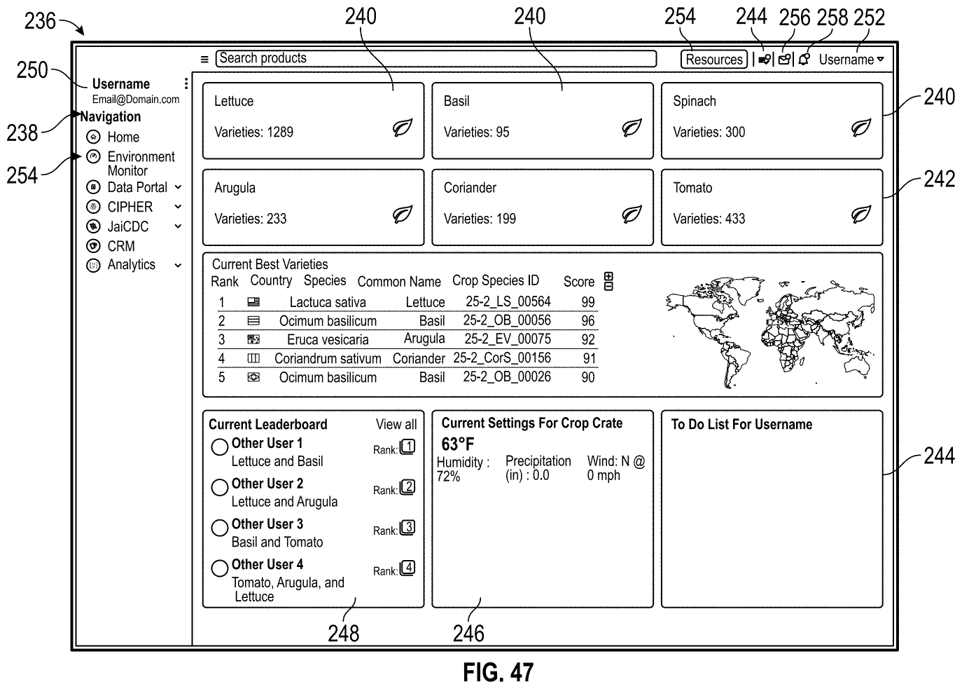

As shown throughout FIGS. 47-51, the graphical user interface 236 allows users to explore seed collections, select new accessions, set up the modular growing system 100, monitor or adjust the system, and share stories. The portal can be designed using an open source engine that navigates users to share insights about their experience on an accession basis.

FIG. 47 in greater particularity shows the user having the ability to access a navigation pane 238 through graphical user interface 236. The navigation pane 238 is a section of the graphical user interface 236 intended to aid users in using electronic resources 254. The navigation pane 238 in some embodiments is implemented directly within the web browser of the online portal and is thus a design element of the particular website.

Also accessible to the user on the graphical user interface 236 shown in FIG. 47, are several seed variety widgets 240 (e.g., lettuce, basil, spinach, arugula, coriander, and tomato). Clicking on the seed variety widgets 240 will allow the user to be able to view and select variety meta data (stored data), genotypic data (which can include whether or not any genetic analysis has been requested and/or status of same), and phenotypic data associated with the selected seed variety.

The passport widget 242 ranks listed seed varieties according to a score relating to which varieties are best. The passport widget 242 displays the country of origin for the seed variety, the species name, the common name, the crop species identifier, and the score used for said ranking. Similarly, a leaderboard 248 ranks users according to their contributions toward gathering, analyzing, and/or predicting scientific data relating to one or more seed varieties. The leaderboard 248 is displayed in FIG. 47 in a table format, though leaderboards could also be presented as a chart or other suitable graphical display. The leaderboard 248 is generally sorted by one primary statistic that drives the rankings.

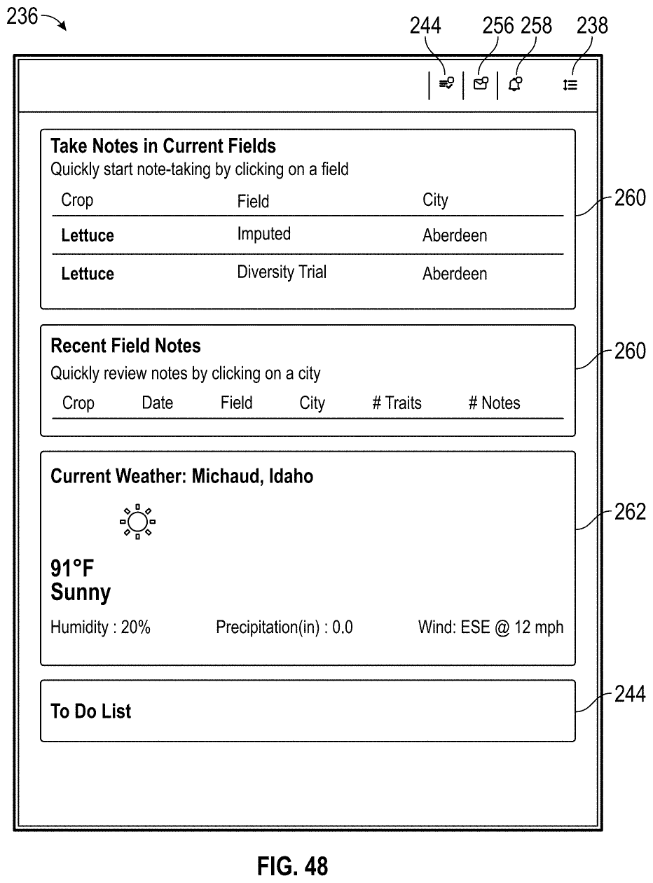

FIG. 47 also includes a to do list 244, which can record and/or even assign tasks relating to the use or maintenance of the modular growing system 100. The user may even be given a timeframe (deadline) in which these tasks must be completed by. The to-do list can be harmonized with the messages and emails 256 and/or notifications 258 functions of the graphical user interface 236. In lieu and/or in addition to the to-do list, a section or widget for tracking notes 260/displaying weather 262 can be employed on graphical user interface 236 (see FIG. 48 for more specific examples).

Where the task is something that can be automatically done by the electrical and mechanical components of the modular growing system 100, the user's ability to access the settings 246 for the modular growing system 100 and/or electronic resources 254 from a remote location can be highly beneficial. For example, the user may be able manually instruct and/or set up automated controls to water his or her plants 164 even while the user has taken a vacation.

Electronic resources 254 can include accessing data regarding seed varieties, requesting genetic tests be completed on specific seed varieties, allowing the user to upload information relating to his or her own work planting, caring for, and/or breeding specific seed varieties and/or plants.

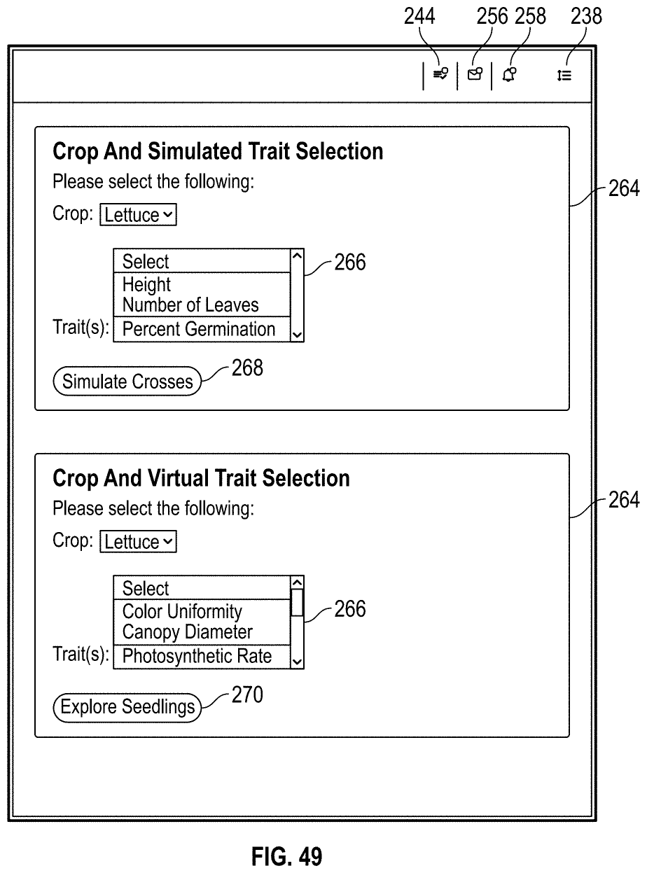

The graphical user interface 236 and virtual assistant, by way of FIG. 49, allow for the user to access crop and simulated trait selection menu(s) 264, select trait(s) 266, simulate crosses 268, and explore seedlings 270.

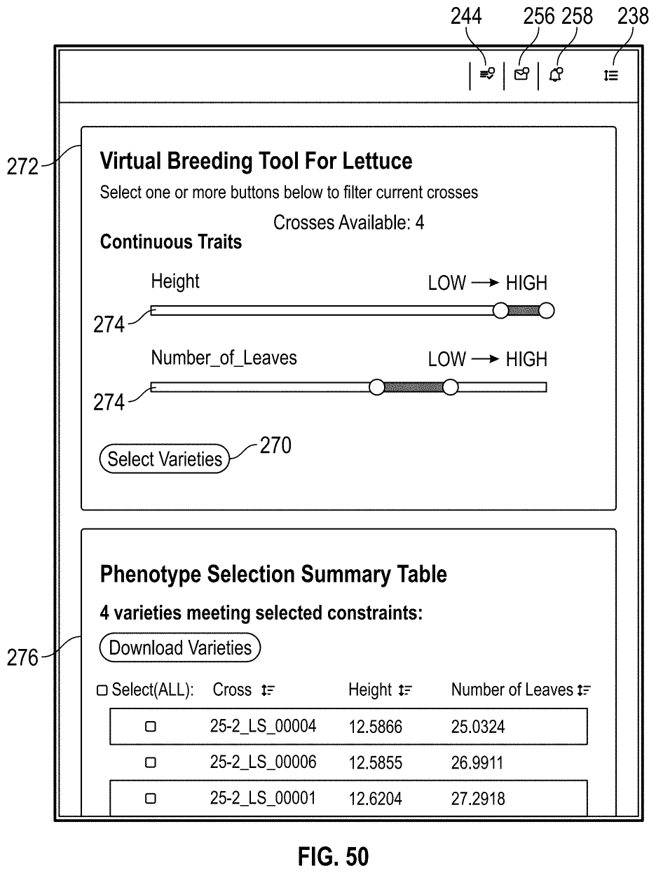

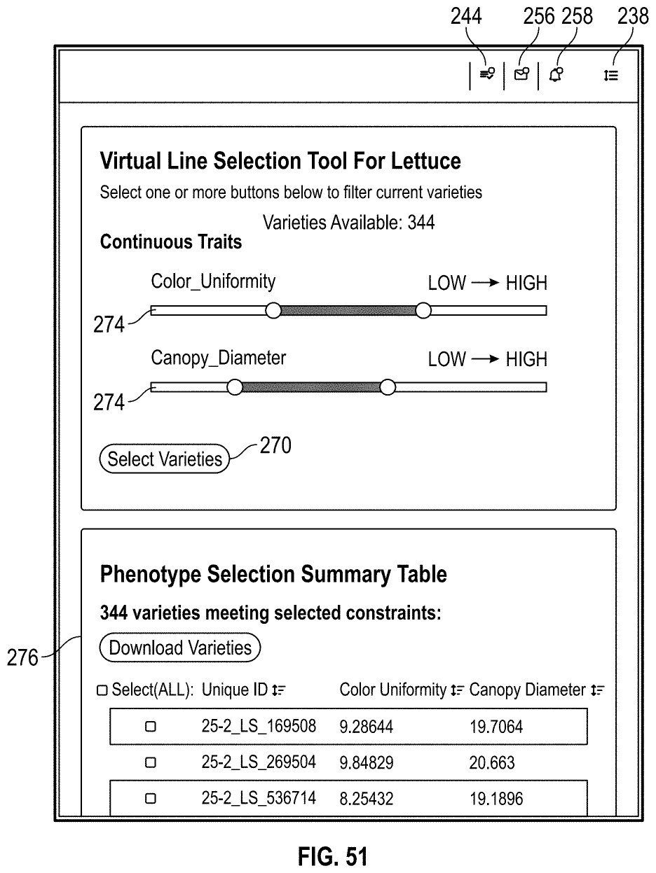

An exemplary virtual breeding tool 272 (FIG. 50) and/or an exemplary virtual line selection tool 278 (FIG. 51) utilize intuitive graphical control element(s) (e.g., slider, trackbar, color wheels, etc.) 274. The graphical control element(s) 274 allow the user to further select a range of values related to selectable trait(s) 266 before simulating crosses 268 and exploring seedlings 270. Simulating crosses 268 and exploring seedlings 270 can result in providing the user with data relating to the simulated cross or selected seedlings via summary table(s) 276.

Other user interface components can be implemented with the graphical user interface 236 so as to better engage the user with the virtual assistant. For example, smart speakers can allow for hands free adjustments to the lighting system and selection of new accessions. Over time, the virtual assistant can be scaled to interact with the customer via voice recognition software. A digital sensory module can assess hedonic components including flavor, texture, aroma, and mouth feel. The digital sensor module will be embedded into the mobile application and work will be done to convert the module into a voice logic schema for use by the virtual assistant. The combination of the preceding elements is both novel and useful because in order to affect a simple user interface (through the application), data redundancies must be removed, and the interface must present only information understandable to the user.

From the foregoing, it can be seen that the present invention accomplishes at least all of the stated objectives.

### LIST OF REFERENCE CHARACTERS

The following table of reference characters and descriptors are not exhaustive, nor limiting, and include reasonable equivalents. If possible, elements identified by a reference character below and/or those elements which are near ubiquitous within the art can replace or supplement any element identified by another reference character.

TABLE 3
List of Reference Characters

| | |
|---|---|
| 100 | modular growing system |
| 100A | growth chamber |
| 100B | root chamber |
| 100C | germination chamber |
| 102 | basket |
| 104 | sidewall |
| 106 | handle |
| 108 | germination chamber planks |
| 110 | root chamber planks |
| 112 | support beams |
| 114 | growth chamber planks |
| 116 | sensor (e.g., CO₂, temperature, relative humidity sensor) |
| 116A | sensor casing |
| 116B | sensor lid |
| 116C | embossed text |
| 118 | structural base for plant roots |
| 118A | two hole base |
| 118B | three hole base |
| 118C | base adapted for barley |
| 118D | reinforced base |
| 118E | base adapted for oats |
| 118F | base adapted for peas |
| 118G | pvc pipe type base |
| 120 | panels (e.g. acrylic, glass, etc.) |
| 120A | front panel |
| 120B | rear panel |
| 120C | side panel |
| 122 | water reservoir |
| 122FC | fluid connection (can halve a flow control therebetween, such as |
| | a valve) |
| 124 | control box |
| 124A | control box lid |
| 124B | control box back plate |
| 124C | control box inner shelf |
| 124D | control box outer casing |
| 126 | electrical cable |
| 128 | full spectrum light |
| 130 | narrow-spectrum light (e.g., purple light) |
| 132 | seedling bay floor |
| 134 | ground level surface of seedling bay |
| 136 | seedling bay supports |
| 138 | seedling bay apertures |
| 140 | base cavity(ies) for roots and seed |
| 142 | base top surface |
| 144 | base bottom surface |
| 146 | central vertical dividers |
| 148 | horizontal fins |
| 150 | peripheral vertical dividers |
| 152 | clip |
| 154 | cap for base |
| 156 | flange |
| 158 | cavity |
| 160 | source identifier |
| 162 | pods (a.k.a. plugs) |
| 164 | plants |
| 166 | container(s) |
| 168 | irrigation system |
| 170 | water level sensor |
| 172 | aerator stone |
| 174 | water pump |
| 176 | hose |
| 178 | growth chamber water return |
| 180 | fuse |
| 182 | water pump switch |
| 184 | upper narrow-spectrum light switch |
| 186 | upper full spectrum light switch |
| 188 | lower narrow-spectrum light switch |
| 190 | lower full spectrum light switch |
| 192 | production number |
| 194 | primary power source for electronic hardware (e.g., AC/DC |
| | converter) |
| 196 | real time clock |
| 198 | system on a chip for control box |
| 200 | bottom white LED lights (full spectrum) |
| 202 | bottom purple LED lights |
| 204 | top white LED lights (full spectrum) |
| 206 | top purple LED lights |
| 208 | 8-block relay board |
| 210 | dual pole-triple throw switch |
| 212 | serial communication port |
| 214 | variable speed fan |
| 216 | analog to digital converter |
| 218 | aerator motor |
| 220 | supplemental power source for supplemental electronic hardware |
| | (e.g., AC/DC) |
| 222 | heating/cooling element in the growth chamber |
| 224 | coupled relay outputs |
| 226 | heat sinks |
| 228 | heating/cooling element in the water chiller |
| 230 | chiller water pump |
| 232 | waterproof water temperature sensor |
| 234 | motor control valve |
| 236 | graphical user interface for using specialized virtual assistant |
| 238 | navigation pane |
| 240 | seed variety widget |
| 242 | passport widget |
| 244 | to do list |
| 246 | settings for modular growing system |
| 248 | leaderboard |
| 250 | account information |
| 252 | sign-in/sign-out option |
| 254 | electronic resources |
| 256 | messages and emails |
| 258 | notifications |
| 260 | notes (e.g., current field notes, recent field notes, etc.) |
| 262 | weather widget |
| 264 | crop and simulated trait selection menu(s) |
| 266 | selectable trait(s) |
| 268 | simulate crosses function |
| 270 | explore seedlings function |
| 272 | exemplary virtual breeding tool |
| 274 | graphical control element (e.g., slider, trackbar, color wheels, |
| | etc.) |
| 276 | summary table(s) |
| 278 | exemplary virtual line selection tool |

### GLOSSARY

Unless defined otherwise, all technical and scientific terms used above have the same meaning as commonly understood by one of ordinary skill in the art to which embodiments of the present invention pertain.

The terms “a,” “an,” and “the” include both singular and plural referents.

The term “or” is synonymous with “and/or” and means any one member or combination of members of a particular list.

The terms “invention” or “present invention” are not intended to refer to any single embodiment of the particular invention but encompass all possible embodiments as described in the specification and the claims.

The term “about” as used herein refer to slight variations in numerical quantities with respect to any quantifiable variable. Inadvertent error can occur, for example, through use of typical measuring techniques or equipment or from differences in the manufacture, source, or purity of components.

The term “substantially” refers to a great or significant extent. “Substantially” can thus refer to a plurality, majority, and/or a supermajority of said quantifiable variable, given proper context.

The term “generally” encompasses both “about” and “substantially.”

The term “configured” describes structure capable of performing a task or adopting a particular configuration. The term “configured” can be used interchangeably with other similar phrases, such as constructed, arranged, adapted, manufactured, and the like.

Terms characterizing sequential order, a position, and/or an orientation are not limiting and are only referenced according to the views presented.

A “user interface” is how the user interacts with a machine. Examples of user interfaces include a digital interface, a command-line interface, a graphical user interface (“GUI”), oral interface, virtual reality interface, or any other way a user can interact with a machine (user-machine interface). User interfaces can include a combination of digital and analog input and/or output devices or any other type of UI input/output device required to achieve a desired level of control and monitoring for a device. Examples of input and/or output devices include computer mice, keyboards, touchscreens, knobs, dials, switches, buttons, speakers, microphones, LIDAR, RADAR, etc. Input(s) received from the UI can then be sent to a microcontroller to control operational aspects of a device.

In communications and computing, a computer readable medium is a medium capable of storing data in a format readable by a mechanical device. The term “non-transitory” is used herein to refer to computer readable media (“CRM”) that store data for short periods or in the presence of power such as a memory device.

One or more embodiments described herein can be implemented using programmatic modules, engines, or components. A programmatic module, engine, or component can include a program, a sub-routine, a portion of a program, or a software component or a hardware component capable of performing one or more stated tasks or functions. A module or component can exist on a hardware component independently of other modules or components. Alternatively, a module or component can be a shared element or process of other modules, programs, or machines.

A “processing unit”, also called a processor, is an electronic circuit which performs operations on some external data source, usually memory or some other data stream. Non-limiting examples of processors include a microprocessor, a microcontroller, an arithmetic logic unit (“ALU”), and most notably, a central processing unit (“CPU”). A CPU, also called a central processor or main processor, is the electronic circuitry within a computer that carries out the instructions of a computer program by performing the basic arithmetic, logic, controlling, and input/output (“I/O”) operations specified by the instructions. Processing units are common in tablets, telephones, handheld devices, laptops, user displays, smart devices (TV, speaker, watch, etc.), and other computing devices.

A “database” is a structured set of data typically held in a computer. The database, as well as data and information contained therein, need not reside in a single physical or electronic location. For example, the database may reside, at least in part, on a local storage device, in an external hard drive, on a database server connected to a network, on a cloud-based storage system, in a distributed ledger (such as those commonly used with blockchain technology), or the like.

“Cloud computing” is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. A cloud computing environment is service oriented with a focus on statelessness, low coupling, modularity, and semantic interoperability. At the heart of cloud computing is an infrastructure comprising a network of interconnected nodes.

The “scope” of the present invention is defined by the appended claims, along with the full scope of equivalents to which such claims are entitled. The scope of the invention is further qualified as including any possible modification to any of the aspects and/or embodiments disclosed herein which would result in other embodiments, combinations, subcombinations, or the like that would be obvious to those skilled in the art.

What is claimed is:

1. A modular growing system capable of growing crops indoors comprising:
a seedling bay, the seedling bay further comprising at least one aperture to receive a seed pod;
a hydroponic and aeroponic growing system further comprising at least one sensor, at least one pump, and an irrigation system adapted to receive the seed pod;
at least one lighting source;
a virtual assistant transmitting a data set from the at least one sensor to a processor, the processor determining a plant health characteristic, wherein the modular growing system further comprises at least two areas for germination of the seed pod and growing a resulting plant; and
an imaging system, wherein the virtual assistant further transmits a data set from the imaging system to the processor;
wherein the imaging system comprises a high-resolution RGB and RBP camera which enables monitoring plant health and growth and transmitting data to a processor, the processor determining a plant health characteristic and transmitting data to a user.

2. The modular growing system of claim 1, the hydroponic growing system further comprising a hydroponic and an aeroponic cycle wherein water and air is provided to the seed pod in a ratio of 1:5.

3. The modular growing system of claim 1, wherein the camera further comprises a 1080p high definition RAW video camera and an 8.1 Mp filtered camera designed to capture blue (468-483 nm), green (543-558 nm), and NIR (835-865 nm) spectra.

4. The modular growing system of claim 1, further comprising a mobile application, the mobile application receiving the data and the mobile application capable of adjusting the at least one sensor, the imaging system, and the at least one lighting source, the mobile application sending a notification to a user.

5. The modular growing system of claim 1, wherein the at least one sensor detects temperature, humidity, oxygen concentration, carbon dioxide concentration, nutrient levels, or lighting levels, wherein the sensor transmits data regarding temperature, humidity, oxygen concentration, carbon dioxide concentration, nutrient or lighting levels to an intelligent agriculture system.

6. The modular growing system of claim 1, wherein the virtual assistant further comprises a user interface, the virtual assistant connecting to a processor, the processor containing information regarding the plurality of seed accessions, instructions for setting up the modular growing system wherein the processor is further connected to the hydroponic and aeroponic growing system and the at least one lighting source, the user interface allowing for a user to control the hydroponic and aeroponic growing system and the at least one lighting system, the user interface further having a section for the user to input text and data.

7. The modular growing system of claim 6 wherein the information is provided with a variety selection tool, a breeding application, or a gene discovery platform.

8. The modular growing system of claim 1 wherein the health attribute comprises growth rate, pathogen presence, nutrient use, tip burn, yellowing, fungal presence.

9. A method for growing plants in an modular indoor growing system according to claim 1 comprising:
enabling users to preferentially select a seed accession from a plurality of seed accessions stored within a computerized database, said plurality of seed accessions being based on data collected on:
(a) agronomic, harvest, hedonic, or consumer preference, and
(b) inputted data generated by at least one machine learning algorithm, the machine algorithms employed by or housed within an intelligent agriculture system; and
providing the user with a seed pod containing the selected a seed related to the selected seed accession, at least one symbiotic bacterium, and at least one plant essential nutrient;
instructing the user to place the seed pod within a seedling bay of the modular indoor growing system;
automatically administering light, water, and/or nutrients to plants growing within said seed pod.

10. The method of claim 9 further comprising administering said light, water, and/or nutrients based upon sensed data, a predetermined schedule relating to a type of the seed, or manual instructions input by a user.

11. The method of claim 9 further comprising allowing results relating to the growth of said plants within the modular indoor growing system to be sourced and uploaded to a computerized database comprising breeding information and key trait data.

12. The method of claim 9, wherein the seed pod further comprises a substrate from the group consisting of peat moss, rhassoul clay, slow release coated Nitrogen (N), Phosphate (P2O5), Potash (K2O), Magnesium (Mg), Sulfur (S), Boron (B), Iron (Fe), Manganese (Mn), Molybdenum (Mo), and Zinc (Zn), and agar, and wherein the at least one symbiotic bacteria is selected from the group consisting of: by Glomus intradices, G. mosseae, G. aggregatum, G. etunicatum, Trichoderma harzianum, Pseudomonas, Isosphaera, Pirellula, Acidothermus, Pseudolabrys, Singusphaera, and Bacillus sp.

13. The method of claim 9, further comprising allowing a plant to germinate and grow to a harvestable condition within two to three weeks.

14. A computerized method for facilitating selection, growth, and/or breeding of plants within a modular growing system according to claim 1 comprising:
creating a data set by capturing information from at least one sensor or an imaging system;
transmitting the data set to a processor, the processor determining a plant health characteristic;
enabling users to develop a new accession by choosing at least one parental line from a plurality of seed accessions, said seed accessions based on data generated by a set of machine learning algorithms employed by an intelligent agriculture system; and
using the accession to select at least one pair of parents to create at least one seed, the seed used to create a line, and the line grown within the modular indoor growing system.

15. The computerized method of claim 14 further comprising sending a notification to a user to adjust any of the sensor data not within a normal range to result in improved plant health, said notification comprising an instruction to input the seed pods, harvest the plant, adjust the water volume, and/or adjust the lighting within the modular indoor growing system.
